(19) United States
(12) Patent Application Publication
(10) Pub. No.: US 2005/0004860 A1
(43) Pub. Date: Jan. 6, 2005

(54) Method and system for determining optimal loan options

(75) Inventors: Eduardo Pretell, Belmont, CA (US); David Bruggeman, San Ramon, CA (US); Yunlong Xue, Pleasanton, CA (US)

Correspondence Address: CHRISTOPHER & WEISBERG, P.A., 200 EAST LAS OLAS BOULEVARD, SUITE 2040, FORT LAUDERDALE, FL, 33301, US

(73) Assignee: E-Loan, Inc.

(21) Appl. No.: 10/611,482

(22) Filed: Jul. 1, 2003

(51) Int. Cl. G06F 17/60

(52) U.S. Cl. 705/38

(57) ABSTRACT

A loan advisory method and system that compares one or more currently available loans and recommends the loan or loans with the lowest cost over the time period the user wants to consider. A computer user is prompted for certain loan information such as the purpose of the loan, whether the user currently owns a home, and other financial information such as whether the user has any existing loans and what the user's goal would be. The invention uses real-time credit-based rates and actual underwriting rules to determine the lowest cost loans for which a user qualifies. A system incorporating the present invention includes a communications network, preferably the Internet, and a server operatively connected to the communications network, wherein the server transmits requests for a user-selected loan purpose. The server further receives a transmittal containing the user-selected loan purpose from each user station and determines which loan or loans are the most cost-effective for each of the one or more users based upon the user-selected loan purpose as well as other loan-related parameters that may be retrieved from external information sources.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to a method and system for providing a user with real time loan advice, and more specifically to a loan advisory method and system for providing a user who desires a loan with the most cost-effective loan available based upon one or more parameters, such as real time interest rates, current underwriting guidelines and upon a variety of user-inputted information such as optimized financial goals, user credit information, and loan purpose.

### BACKGROUND OF THE INVENTION

When it comes to choosing which loan package is best, the enormous number of available loan choices often intimidates and confuses the public. Members of the public seeking personal loans in order to buy a vehicle or a home, save on a current mortgage or current vehicle loan, or to simply obtain a cash advance are often skeptical and hesitant to trust lending companies and banks. Additionally, many members of the public are experiencing the ease of using the Internet to accomplish tasks that previously could only be accomplished by leaving the house or office to go to an established “brick and mortar” lending institution.

It is often intimidating to walk into a bank or other lending institution to discuss taking out a personal loan. Additionally, the person seeking the loan must fill out what seems like reams of paperwork, a time-consuming task. In recent years, loan advising models have become fairly commonplace via the Internet, allowing users to enter information on-line and obtain loan recommendations. Current models allow the user to enter particular personal financial information in order to compare the user's current mortgage against another, or in order to obtain recommendations regarding a particular loan type. For example, one type of model provides loan advice strictly for mortgages while another provides loan advice for home equity loans. Other types of Internet models provide loan information without utilizing important user financial criteria such as credit ratings or without considering current, real-time interest rates.

Many of the Internet tools dispensing loan advice do not take into account all the options available to the borrower that could satisfy the borrower's need. For example, if the borrower is interested in seeking a loan in order to buy a vehicle, a series of home and vehicle loan products can be considered; these products are different than the products available if the customers want cash. Other models fail to consider exactly what type of financial goals the borrower has in mind, i.e., is the borrower seeking to minimize after-tax interest costs, or to keep their total payments at a minimum?

It is therefore desirable to have a loan advisory method and system that receives loan parameters from a user, such as the purpose of the loan, whether the user owns a home, the user's current loan information, the user's current credit rating, the user's tax rate, the user's rate of return, and processes these loan parameters along with current underwriting parameters, performs real-time searches for all applicable loan types, calculates the optimal loan(s) and suggests these loans to the user.

### SUMMARY OF THE INVENTION

The present invention advantageously provides a method and system that compares currently available mortgage, home equity, and vehicle loans and recommends the loan or loans with the lowest cost over the time period the user wants to consider. A user is prompted for certain loan information such as the purpose of the loan, whether the user currently owns a home, and other financial information such as whether the user has existing loans and what the user's preferred savings scenario, or goal, would be. The method and system then uses real-time credit-based rates and actual underwriting rules to determine the lowest cost loan(s) for which a user qualifies.

The user starts by selecting the reason for needing a new loan and whether or not they own a home. If the user does not own a home and the user is seeking to obtain a cash loan or is seeking to purchase, or refinance a vehicle, there is only one type of loan choice for the user and they are directed to the appropriate personal or vehicle loan sections of the host website. The terms “vehicle”, “auto” and “automobile” are used interchangeably throughout this document and shall define automobiles, motorcycles, or any other device for transporting persons or things. If the user does own a home, or is seeking to purchase a home, the user is asked to complete a series of questions related to their current or desired mortgage(s), desired goal, tax rate, hold period, rate of return, and vehicle loan, for vehicle refinance users or for new vehicle purchasers.

The present invention receives these inputs and seeks to find the lowest cost loan(s) using the goal the user requested. If the user chooses to “Minimize total payments”, the system seeks to provide a low monthly payment, but also considers the closing costs associated with the loan and mortgage insurance. If the user chooses to “Minimize after-tax interest costs”, the system compares the after-tax interest plus closing costs and mortgage insurance to provide users with the loan that will minimize non-principal payments. The present invention incorporates a real-time rate search using the user's credit score or estimated credit history, as well as other qualifying underwriting criteria such as minimum and maximum loan amounts and loan-to-value ratios, property type, use and property or transaction location. It then uses all this information to calculate and compare the monthly payments and interest costs of every qualifying loan and suggest the optimal loan option(s) and loan(s) to the user.

Users that seek to refinance their home or to obtain cash may receive a mortgage and/or a home equity loan or line of credit as the recommended loan option. In addition, vehicle purchase and vehicle refinance users may receive a vehicle loan, mortgage and/or home equity loan or line of credit as the recommended loan option. Users seeking to purchase a home may receive a mortgage or a first and second mortgage combination as the recommended loan options. If the user is looking for a home refinance or a vehicle refinance loan and they cannot save money with a new loan, the user is informed of this and not presented with any loan options.

Features of the invention can be implemented in a variety of ways, including a method, a system, software instructions stored in a computer readable medium such as a CD-ROM, or software stored and maintained on a web server where data associated with the invention may be accessed via browsers on the user's terminals.

In accordance with one aspect of the present invention, a method for recommending loans to a user based upon a selected loan purpose is provided. The method comprises the steps of requesting from the user a purpose for the loan, receiving the user-selected loan purpose, and recommending loans for the user based upon the user-selected loan purpose.

In accordance with another aspect of the present invention, a system is provided for recommending loans to a user associated with a respective user station. The system comprises a communications network, and a database server operatively connected to the communications network, wherein the database server is capable of transmitting to the user stations via the communications network, requests for a user-selected loan purpose, each said user station being associated with a respective display terminal for displaying a web page, the database server further capable of receiving a transmittal containing the user-selected loan purpose from each said user station and recommending loans for each of the one or more users based upon the user-selected loan purpose.

In accordance with yet another aspect, the invention comprises a machine readable medium having instructions stored thereon for execution by a processor to perform a method of recommending loans to a user based upon a user-selected loan purpose. The method comprises requesting from the user a purpose for the loan, receiving the user-selected loan purpose, and recommending loans for the user based upon the user-selected loan purpose.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 illustrates an exemplary structure of the system embodying the present invention;

FIG. 2 is a flow chart of the process performed by the present invention when interfacing with a user that is not a homeowner;

FIG. 3 is a flow chart of the process performed by the present invention when interfacing with a user that is a homeowner;

FIG. 4 is an introductory web page presented on a user's terminal incorporating the present invention;

FIG. 5 is an alternate introductory web page presented on a user's terminal incorporating the present invention;

FIG. 6 is a web page presented on a user's terminal for a user who is not a homeowner and wishes to obtain cash;

FIG. 7 is a web page presented on a user's terminal for a user who is not a homeowner and wishes to purchase a vehicle;

FIG. 8 is a web page presented on a user's terminal for a user who is not a homeowner and wishes to purchase a new vehicle from a franchised vehicle dealer;

FIG. 9 is a web page presented on a user's terminal for a user who is not a homeowner and wishes to refinance their current vehicle loan;

FIGS. 10A and 10B are web pages presented on a user's terminal for a user seeking to obtain a loan in order to purchase a home;

FIGS. 11A and 11B are web pages presented on a user's terminal for a homeowner seeking to obtain a loan in order to purchase a vehicle;

FIGS. 12A and 12B are web pages presented on a user's terminal for a homeowner seeking to obtain a loan in order to refinance their home;

FIGS. 13A and 13B are web pages presented on a user's terminal for a homeowner seeking to obtain a loan in order to refinance their vehicle;

FIGS. 14A and 14B are web pages presented on a user's terminal for a homeowner seeking to obtain a loan in order to obtain cash;

FIGS. 15A and 15B are web pages presented on a user's terminal requesting information about the user's current loans;

FIG. 16A-16C illustrate a web page presented on a user's terminal suggesting the most cost-effective mortgage loans;

FIGS. 17A and 17B are web pages presented on a user's terminal suggesting the most cost-effective home equity loans;

FIGS. 18A and 18B are web pages presented on a user's terminal suggesting a home equity loan as the borrower's only mortgage; and

FIGS. 19A and 19B are web pages presented on a user's terminal suggesting an automobile loan.

### DETAILED DESCRIPTION OF THE INVENTION

Initially, it is noted that the terms “automobile”, “auto”, “car” and “vehicle” are used interchangeably herein to refer to any type of vehicle. As such, the present invention is not intended to be limited solely to passenger automobile applications.

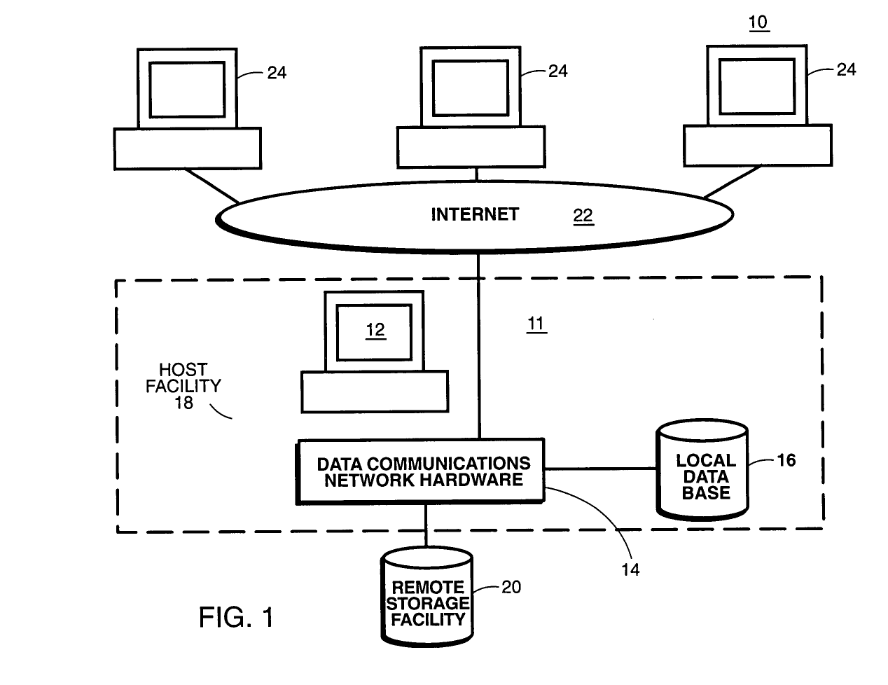

Referring now to the drawing Figures in which like reference designators refer to like elements, there is shown in FIG. 1 an exemplary embodiment of a system constructed in accordance with the principles of the present invention, designated generally as 10. The present invention provides a system and method for presenting users with the most cost-effective loans based upon a variety of loan data criteria provided by the user.

System 10 includes a server 11 comprised of a database service computer 12 operatively coupled to data communications network hardware 14. Computer 12 may be one or more computers, or network of computers capable of hosting a web site. Computer 12 may be a personal computer, minicomputer, or a mainframe, which offers data management, network administration and security. Network hardware 14 may consist of one or several processors that host a web site incorporating the present invention as well as standard computer storage components such as Random Access Memory (RAM), Read Only Memory (ROM) and hard disk storage devices, as well as external memory devices such as compact disks, magnetic tape and the like. Network hardware 14 includes additional processors that process the software instructions housed in the storage components in order to carry out the calculations required to determine the most cost-effective loan options for each user using data stored in a local database 16 and/or a remote information storage facility 20.

The term “server” as used in this application refers to computer 12, network hardware 14 and all software stored thereon. Server 11 stores a variety of web pages that can be accessed by browser software on the user's terminal, receive user loan criteria, retrieve information from both local and remote information storage facilities, calculate the optimal loan choice for a specific user utilizing a variety of stored algorithms and suggest to the user the optimal loan choice or choices that have been determined.

Electrically coupled to network hardware 14 is local database 16. Database 16 is preferably located within host facility 18. Database 16 may store user profile records. These records are created when a user contacts the host website and requests loan information, loan rates and underwriting guidelines. The user is then asked to enter his or her name and a password to identify the user for future login scenarios. Database 16 is preferably any known database system such as a relational or object oriented database system that can be programmed to support the data required to maintain a user listing and to identify the use by their login information.

Remote information storage facility 20 may be operatively coupled to hardware 14. Remote facility 20 may contain certain commercially available financial information such as current interest rates and other consumer-specific data such as a particular user's current loan status of current credit rating. The user's current loan status may include, but is not limited to, such factors as the type of loan(s), the interest rate on the user's current loan(s), the origination date of the loan(s) and the loan term. Information storage facility 20 also includes information regarding available loans including home equity loans, mortgages and automobile loans, and particular underwriting guidelines for each loan option. Alternately, information such as current interest rates, consumer-specific data and other financial information may be stored internally in database 16.

Loan rates are periodically downloaded from information storage facility 20 to service server 11, for example, one or more times a day, such that real-time data is used in the analysis that will provide the user with the most cost-effective loan choice. It is well understood that one or more such databases may comprise what is referred to as information storage facility 20. Facility 20 may be comprised of multiple hardware devices such as central processing units (CPUs) and/or storage devices such as CD-ROMs, hard disk drives or tape drives that can communicate via a communications network. Further, information storage facility 20 may refer to virtually any external information source such as internal proprietary database, external database and online information services from which information may be extracted.

A data communications network 22 couples network hardware 14 to one or more user terminals 24. Network 22 is preferably the Internet, but can be an intranet or virtual network, or any network capable of communicating data between user terminals 24 and hardware 14. User terminals 24 may represent any type of known computers capable of supporting a web browser, such as Personal Computers (PCs), Personal Digital Assistants (PDAs), such a Palm Pilot™, a cell phone or an interactive television. The present invention is not limited by any particular physical communication device and can employ any device that provides graphical, interactive access to the Internet.

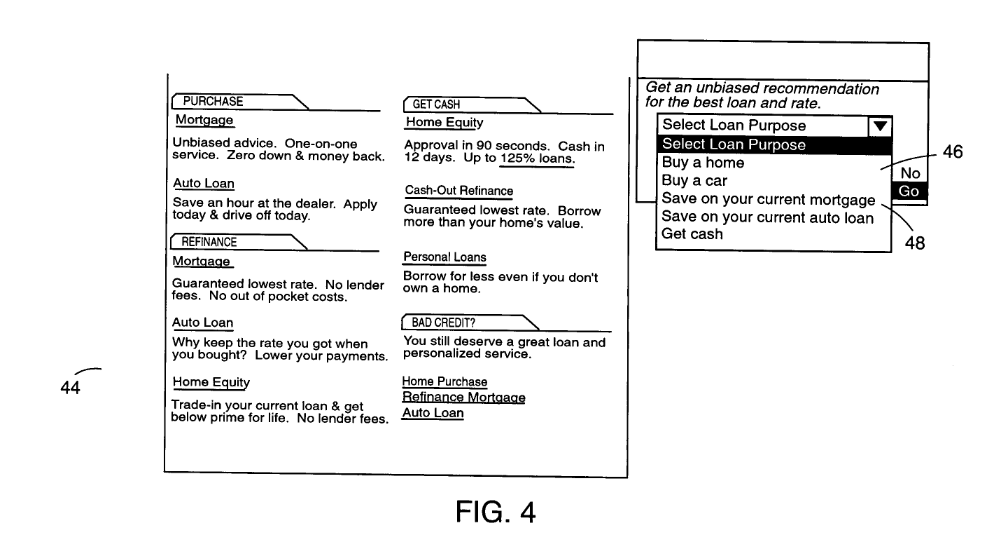

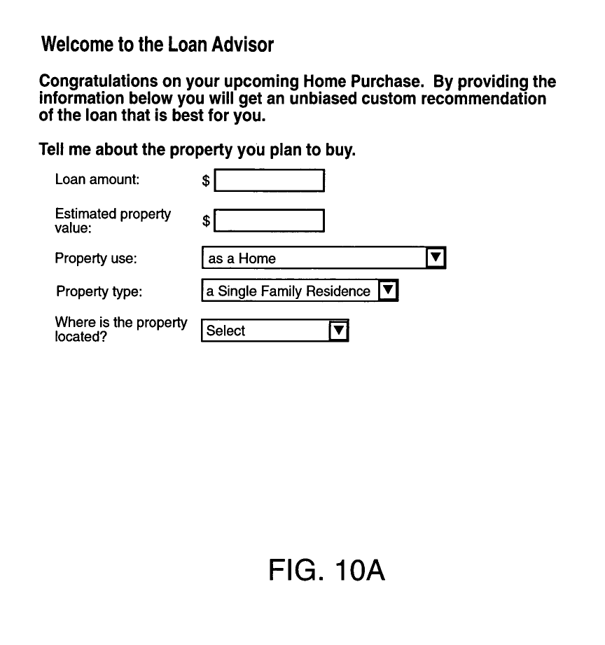

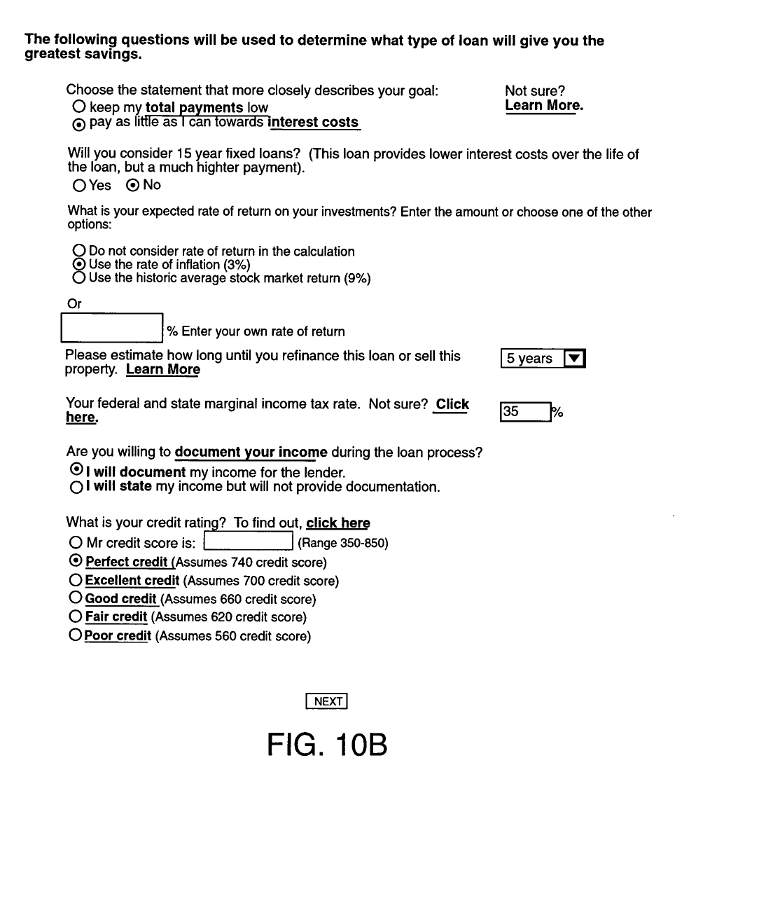

A user electrically contacts the host website supporting the present invention to establish a user profile. The host website creates a user file in database 16. Each user profile preferably includes a user name and corresponding password using the user name and password. A user at user terminal 24 accesses the host website hosted on service computer 12. Firewalls, data encryption and other hardware and software security measures that are well known in the art may be used to insure that unauthorized users cannot gain access to computer 12. However, any user, including those that have not entered user profile data, may contact the host website and access the loan advising system of the present invention. Users wishing to obtain quick, current and accurate loan guidance are presented with a series of interactive web screens, which guides them through the necessary steps in order to present them with the loan options best suited to the users' requirements. These interactive screens are discussed further below in greater detail and illustrated in FIGS. 4-19B. Figures with multiple subsections (i.e. FIGS 10A and 10B) represent the same screen after the user has scrolled down to view the remainder of the web page.

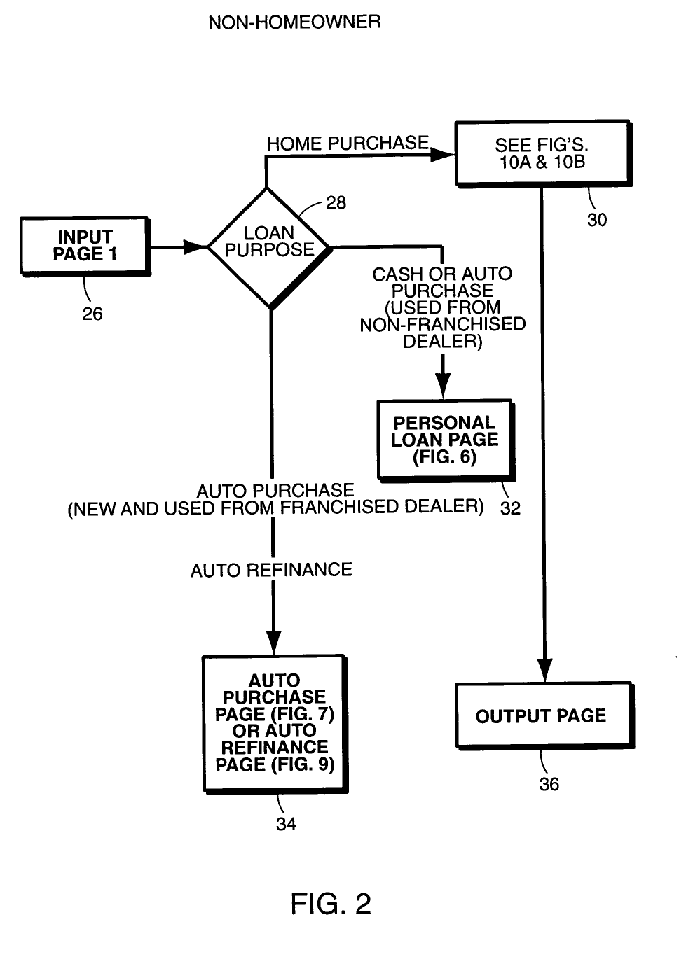

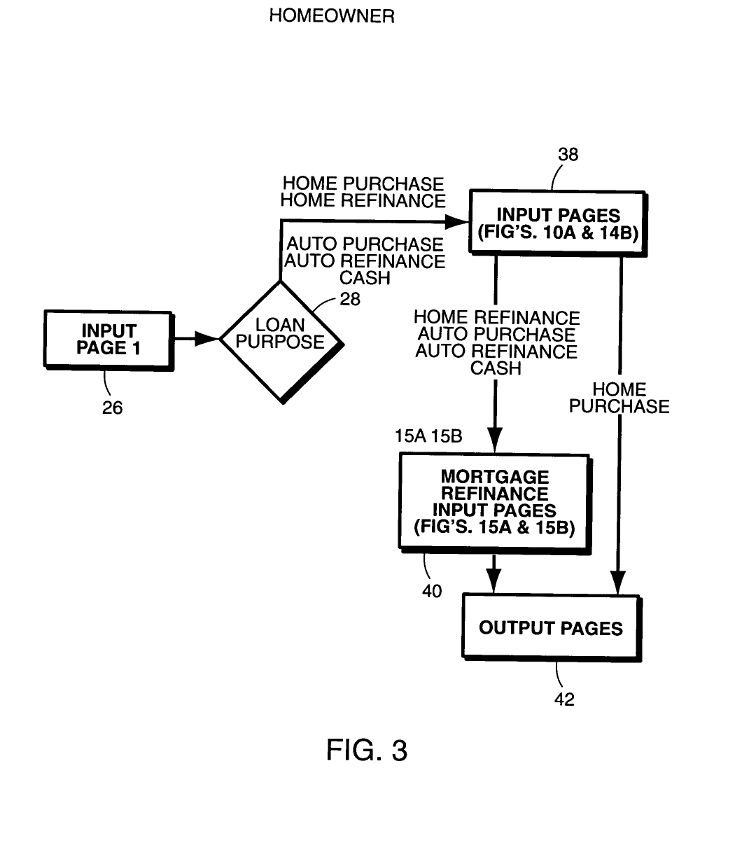

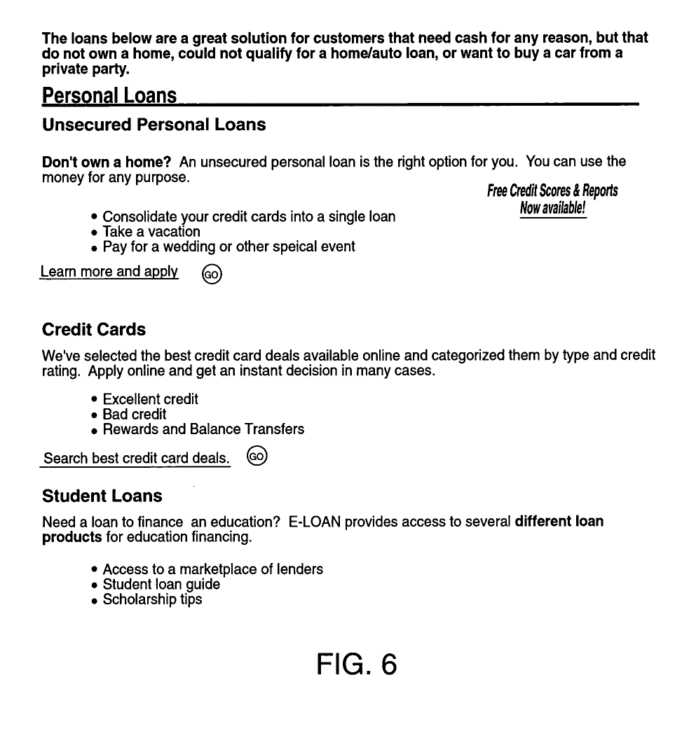

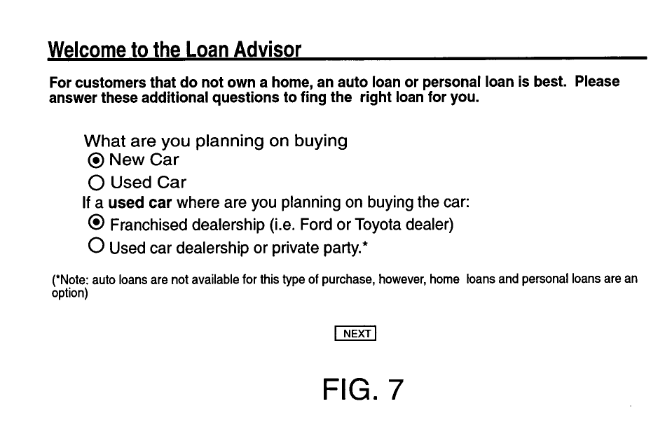

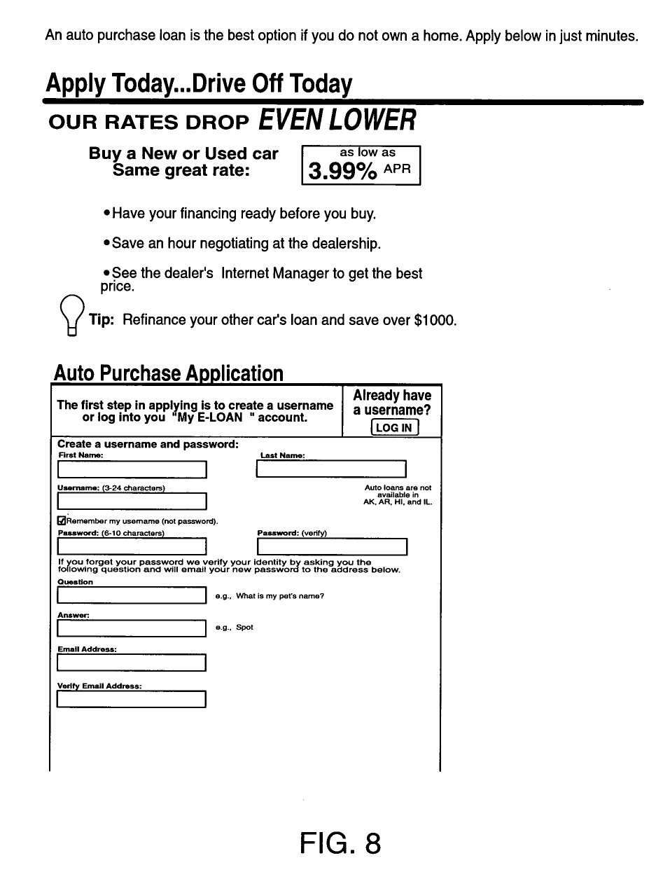

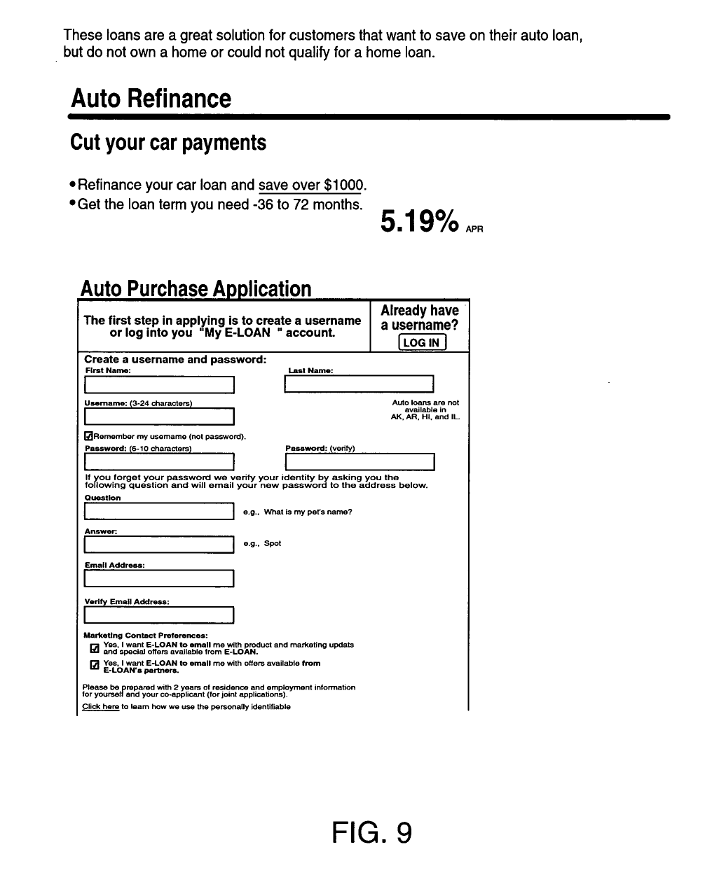

Referring now to FIGS. 2 and 3, flowcharts are presented which illustrate the steps performed by the present invention in determining the optimal loan choice for a particular user. The loan advising system and method of the present invention takes into account the user's loan purpose as well as other user-supplied and external criteria before calculating the ideal loan or loan choices for the user. At the host website, the user is presented with an input page 26 requesting that he or she select a loan purpose (step 28), and to identify whether or not the user is a homeowner. If the user is not a homeowner but wishes to purchase a home, the user is then presented with the web pages shown in FIGS. 10A and 10B (step 30). If the user is not a homeowner but wants to obtain cash, or wishes to purchase an automobile in a situation where a vehicle loan is not available, the user is presented to the personal loan web page shown in FIG. 6 (step 32). If the user is not a homeowner and wishes to either purchase a new or used automobile in a situation where a vehicle loan is available or wishes to refinance their existing vehicle loan, the user is directed to the web pages shown in FIGS. 7 and 9, respectively (step 34). The screen shown in FIG. 8 is presented to the user if he or she wishes to obtain a loan for the purchase of a new vehicle in a situation where a vehicle loan is available. Step 36 presents the user that owns a home with web pages recommending the most cost-effective loans.

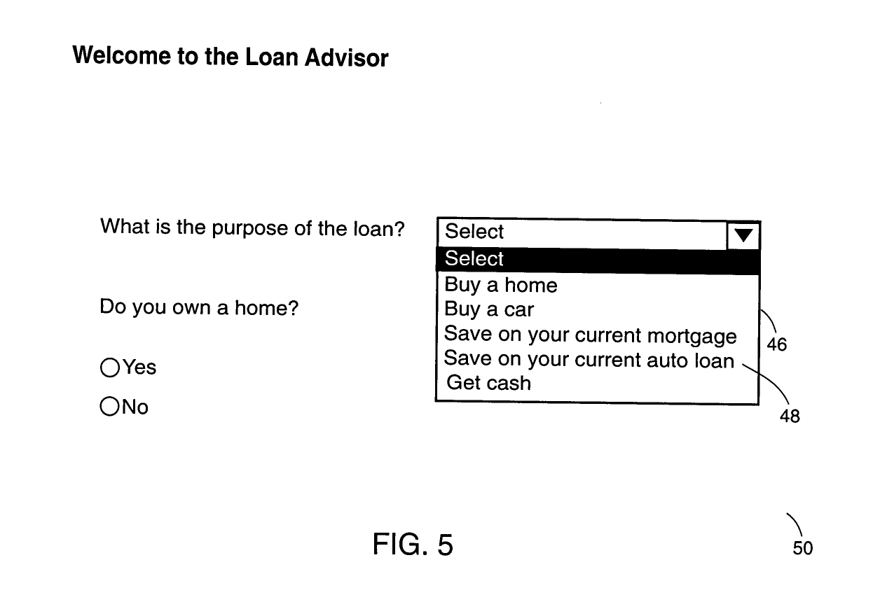

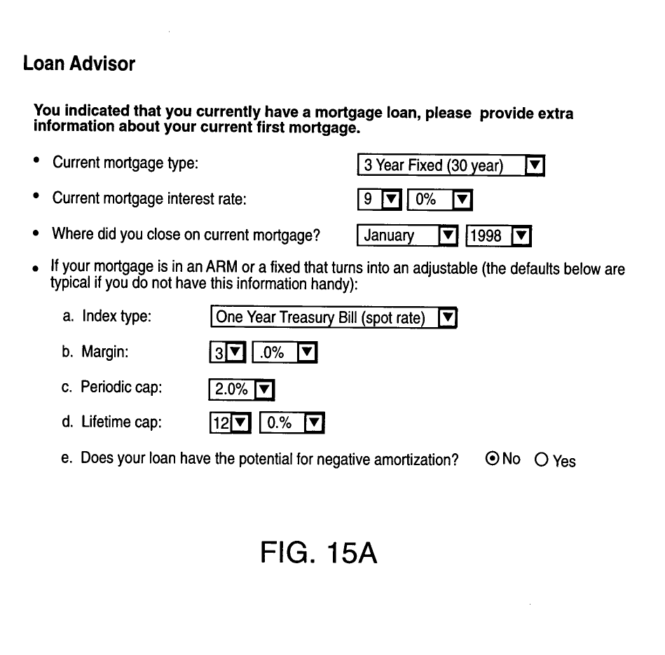

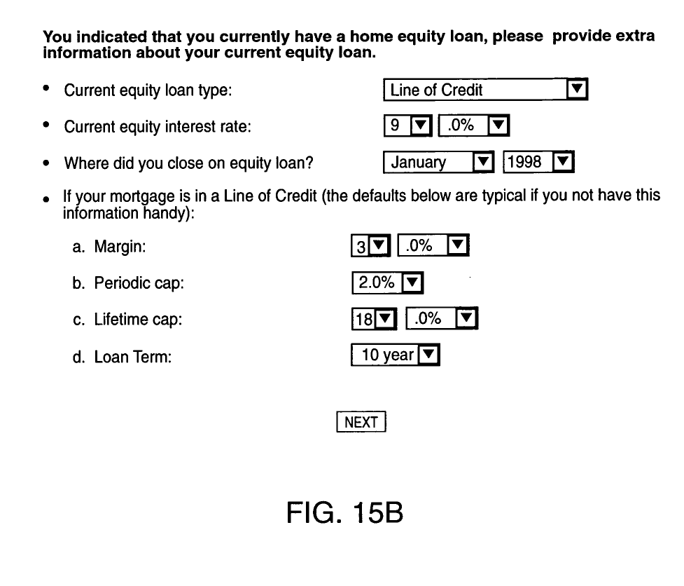

Referring now to FIG. 3, users that indicated that they are homeowners, via the menus shown in FIG. 4 or FIG. 5, are queried as to the purpose of their loan (step 28). Depending upon which loan purpose is selected, the user is presented with one of the input web screens 38 shown in FIGS. 10A through 14B. If the user owns a home and wishes to refinance his or her current mortgage, a new input page 40 is presented to the user, shown in FIGS. 15A and 15B.

Once server 11 receives the pertinent loan-related information from the user, whether it was supplied initially (from the initial menu) or after a query, other information that may be needed to calculate the most optimal loan for that user is obtained from an external information source, such as remote database 20, and the user is presented with an output page 42. Output page 42 can be one of several different output pages specifically tailored for the type of loan requested. This is explained in greater detail further below.

Therefore, FIGS. 2 and 3 illustrate the specific steps taken by the present invention in order to determine which loan or loans are most cost-effective to a user. As is shown in step 28, the user's loan purpose is required for optimal loan decisions regardless of whether the user owns a home (FIG. 3) or not (FIG. 2). Once the user's loan purpose is received, various other display screens are presented to the user in order to obtain additional loan-related input parameters, determine which loan is the most cost-effective for the user based upon the user-selected loan purpose and the additional loan-related input parameters, and recommend to the user the most cost-effective loan that is currently available. Some of the loan-related input parameters used in the calculation by the invention may include, but are not limited to, such factors as the user's credit rating, the available loan amount, the loan to value ratio, the combined loan to value ratio, the property type, the property use, and income documentation and location, i.e. the state where the user resides.

FIG. 4 illustrates a sample home page 44 of host facility 18. This home page is presented on a user's screen as the initial display screen once the user has accessed the host facility web site. In other words, home page 44 is the gateway, which allows users to access the functions provided by system 10. Page 44 includes a loan purpose selection menu 46, which lists a plurality of loan purposes 48. For example, menu 46 may list “Buy a home”, “Buy a car”, “Save on current mortgage”, “Save on current auto loan”, and “Get cash”. The menu 46 depicted on FIG. 4 represents an embodiment of the present invention. The menu may include less choices, or additional choices. It is within the scope of this invention to allow the user to select from a variety of loan purpose options. Alternately, the user may access the loan advisement system of the present invention without entering a choice from menu 46 on home page 44. If the user first chooses to access other information from home page 44, he or she will be prompted with a link to take them to an alternate input screen such as the screen 50 shown in FIG. 5. Once again, a menu is presented to allow the user to choose a loan purpose.

Regardless of which screen the user chooses to access the menu from, he or she is presented with an additional query in addition to the listing of loan purposes. The user must indicate if they own a home in order to determine whether mortgages or home equity loans are possible loan options to be considered. As such, the present invention requires that this information be entered in the initial stages of the process. If the user's loan purpose is to obtain cash and the user does not own a home, server 11 presents the user with a web page similar to the one represented in FIG. 6. In this scenario, because the user does not own a home, server 11 does not to query the user for any additional information or retrieve any information from external sources. Instead, server 11 presents the user with a choice of possible unsecured loan options. Loan options are not specific loans, but instead are categories of loans that may be of interest to the user. FIG. 6 shows a number of these options. Non-homeowners can get cash with an unsecured loan such as a personal loan, ore credit card.

If the user that does not own a home and indicates a desire to purchase a vehicle, server 11 presents the user with a screen similar to the one shown in FIG. 7. Here, server 11 requires additional loan-related user input parameters to determine the best loan. The user is presented with two queries, namely whether the vehicle the user intends on purchasing is new or used, and whether the vehicle will be purchased from a franchised dealership or a used vehicle dealership or private party. These questions are currently used to determine eligibility for currently-available vehicle loan options, but these questions may be dropped, changed or supplemented as underwriting criteria changes. If the user selects a “new car”, or if the user plans on purchasing a vehicle from a franchised dealership, server 11 presents the user with a screen shown in FIG. 8, allowing the user to apply for such a loan. The user is then prompted to enter his or her user name and password in order to apply for an automobile loan directly through the host site. If the user instead elects to purchase a “used car” from a non-franchised dealership (which may be considered an ineligible loan purpose), the user is again presented with the display screen shown in FIG. 6, and unsecured loan options will be presented. Finally, if the non-homeowner user seeks a loan in order to refinance an existing automobile loan, the display screen shown in FIG. 9 is presented to the user. Once again, the user is prompted to enter his or her login account information and can apply for a loan through the host site.

The web screens shown in FIGS. 6-10B are presented to users who do not own homes. However, if a user already owns a home or is looking for the best available loan for a new home purchase, server 11 presents the user with an entirely different set of web screen and interactive queries, and the process shown in FIG. 3 is invoked. A user wishing to obtain a loan in order to purchase a new home is presented with the screen shown in FIGS. 10A and 10B. The user is prompted to enter loan-specific details such as the amount of the loan requested, the estimated property value, in what manner the property is going to be used, i.e. primary residence, a second or vacation home, or as an investment, and the state where the home is going to be located. Further, the user is prompted to indicate what their expected rate of return is on the user's investment. For example, the user is asked whether they want the expected rate of return to be considered in the calculation, whether to use the current inflation rate or to use the historic average stock market return in the calculation. Some or all of these factors are used by server 11 in calculating the best available loan for the user. All of the user's initial input factors are initially used in calculating the optimal loan option. However, some factors, after being considered may not ultimately be used in the final determination of the qualifying product.

However, the server 11 will not allow the user to navigate beyond the screen shown in FIGS. 10A and 10B until he or she enters additional cost-savings information. In particular, the user must elect whether he or she wishes to minimize the total loan payments or to pay minimal after-tax interest costs. If the user selects the “minimize total payments” option, server 11 searches for loans that provide low monthly fees but will also consider closing costs associated with the loan and mortgage insurance. If the user selects the “minimize after-tax interest cost” option, server 11 compares after-tax interest plus closing costs and mortgage insurance, discounted to account for the time value of money, to provide users with a loan that minimizes non-principal payments. The user is requested to enter additional loan-related information such as how long until the user intends to refinance the loan or sell the property, the user's federal and state income tax rate, the rate of return/inflation the user wishes to use, and the user's credit rating. If the user does not know their credit rating, the server can retrieve this information from remote information sources, such as database 20.

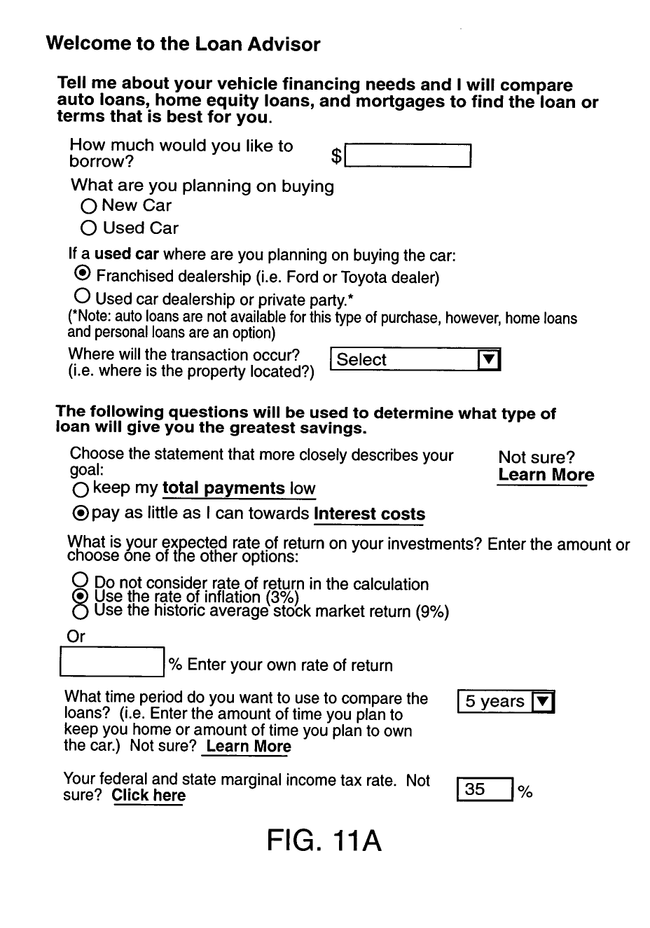

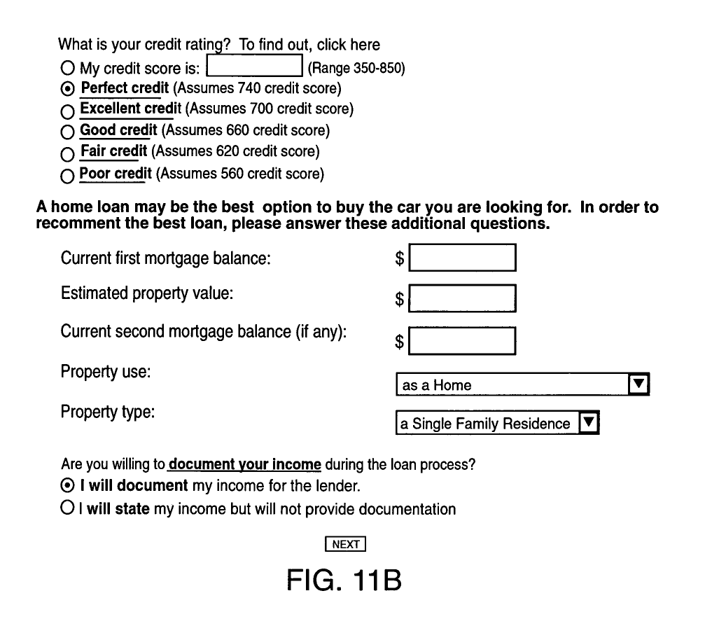

The loan advising system of the present invention performs a real-time interest rate search using the loan parameters submitted by the user, including the user's current credit rating, property information, current loan information, and desired loan/amount of cash information to obtain all available loan options. In the case of a new home purchaser, the available loan options may be a mortgage or first and second mortgage combination. For each of the loan options, an optimal loan choice is presented to the user. Server 11 determines the “optimal loan choice” after it has calculated each of the available loans, based upon the user's requirements. The calculations are based upon the algorithms presented below. Server 11 then presents the user with the most affordable loan, based upon the user's preference to either minimize total payments or to minimize after-tax interest payments. If desired, more than one loan choice is presented for each loan option. Similarly, if the user (homeowner) seeks a loan in order to purchase a vehicle, a different screen is presented to the user, such as the screen in FIGS. 11A and 11B. Once again, the user responds to a series of queries and in response, server 11 supplies a list of available loan options, along with the most cost-effective loan choice for each loan option. Again, the “most cost-effective loan choice” is determined after server 11 has determined the cost to the user for each available loan choice, using the algorithms presented below and considering the user's savings preferences.

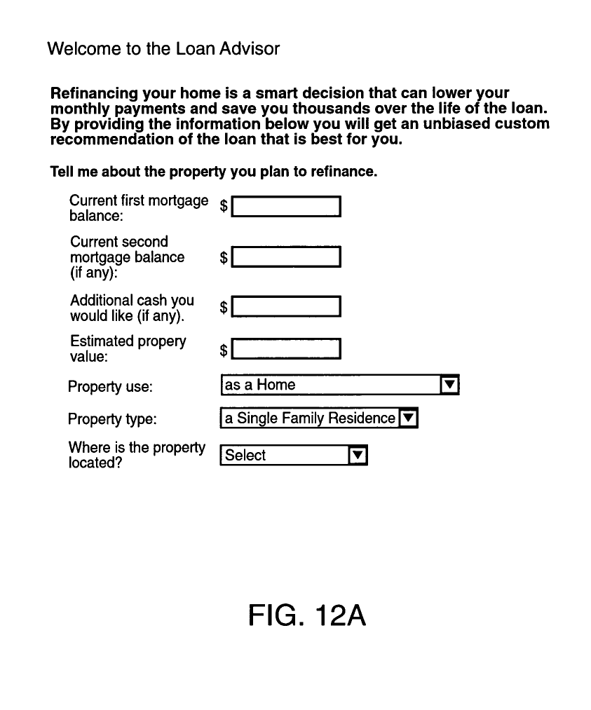

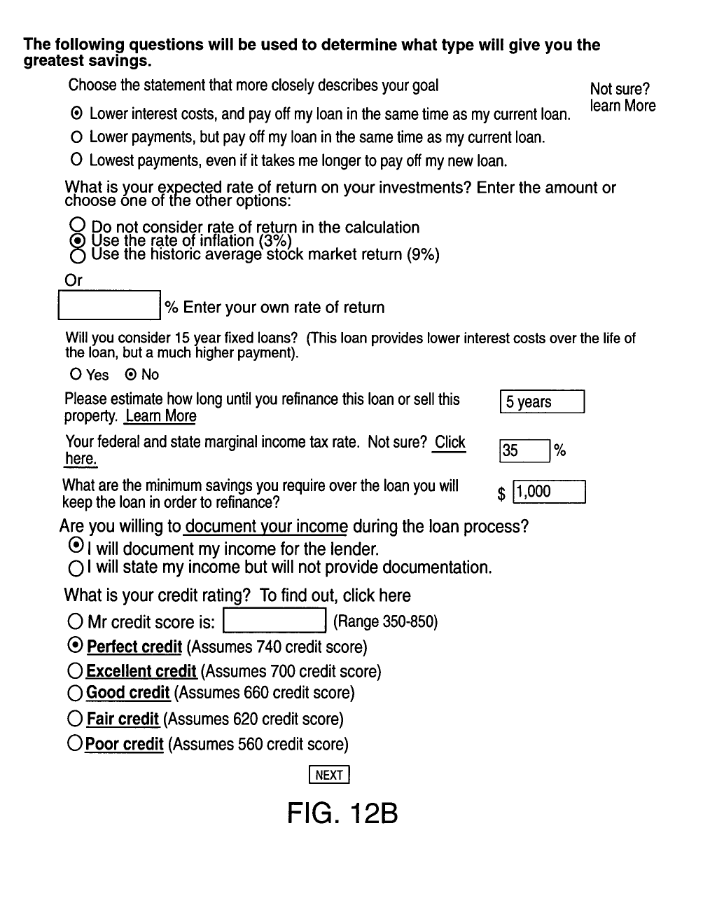

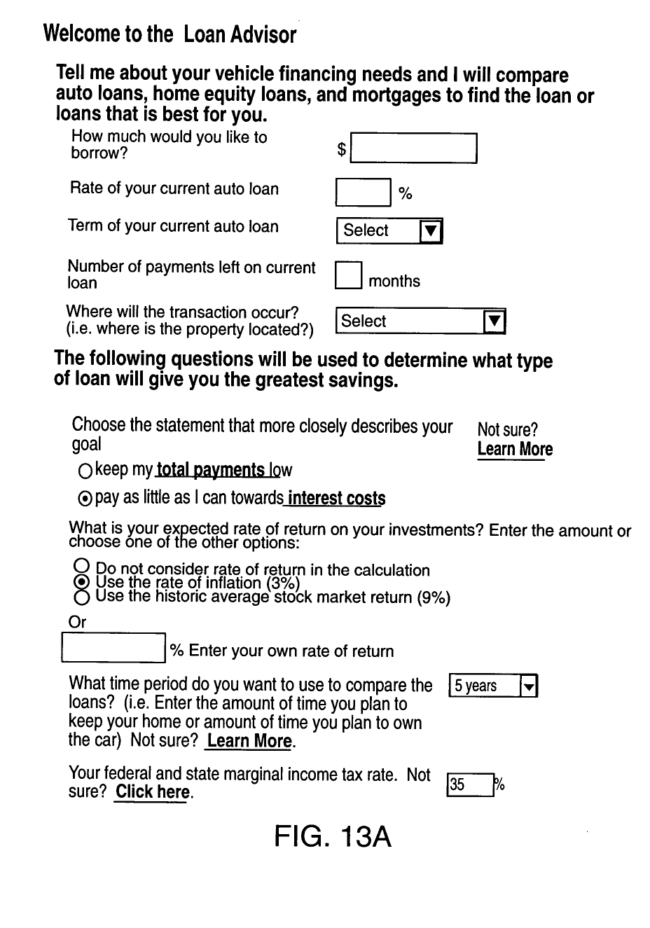

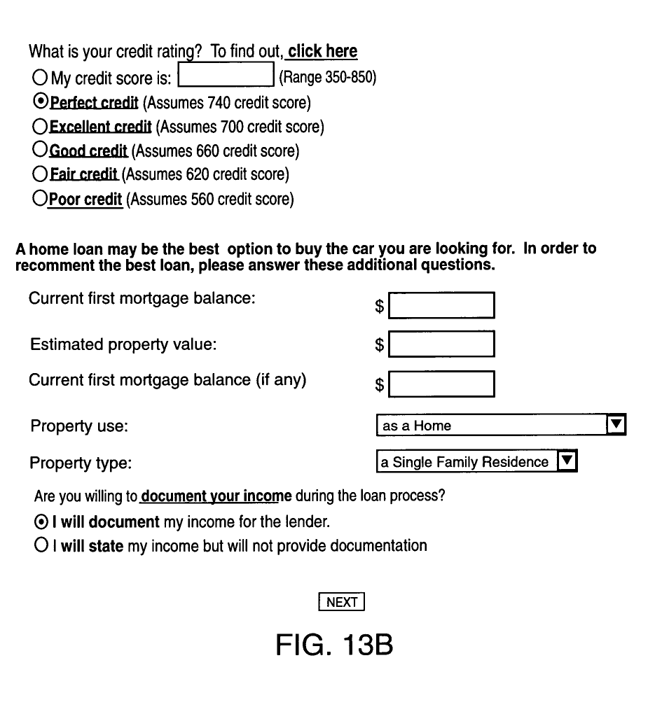

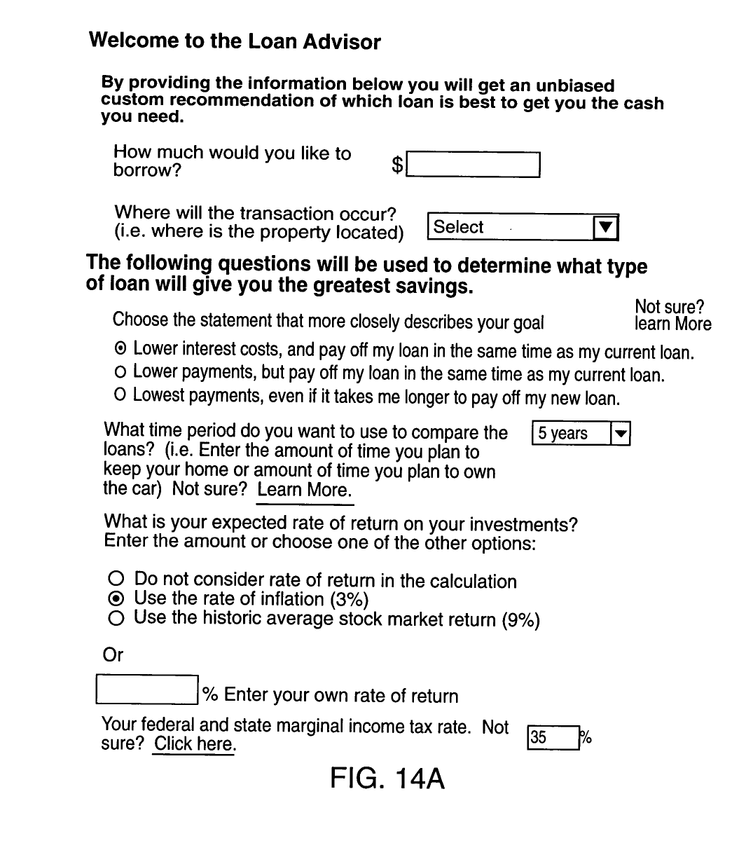

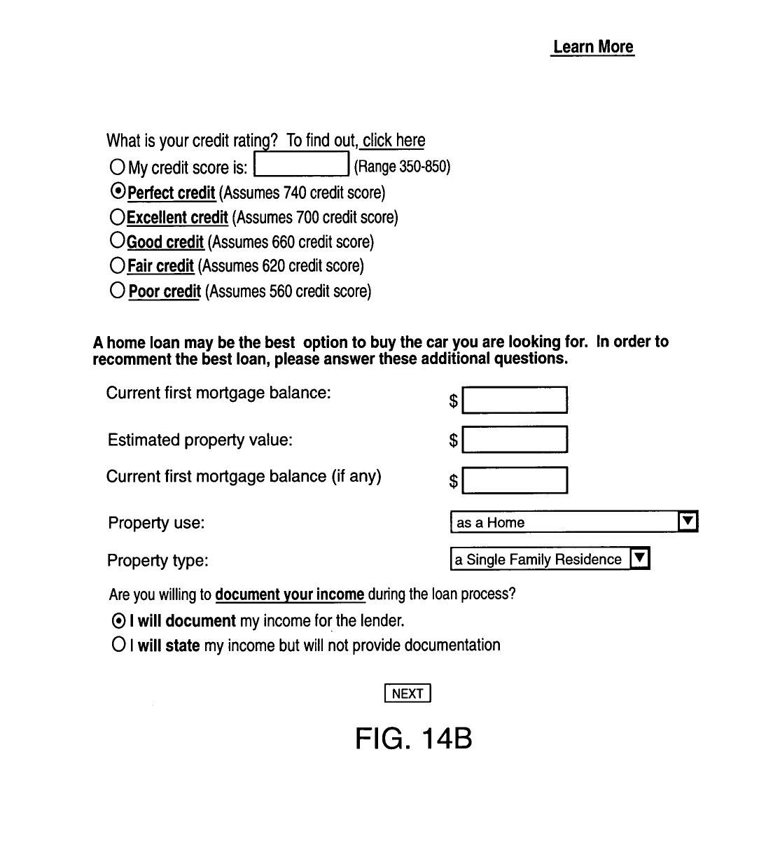

Examination of FIG. 11B reveals an additional query presented to a user who seeks out loan information in order to purchase a new automobile. The user is asked if he or she presently has a mortgage or second mortgage, the type of property, use of the property, and the balance of the loan(s). This information is processed by server 11, along with all other user-specific loan information, and cost-effective loan options and specific loans are presented. Screens presented to users wishing to refinance their homes (FIGS. 12A and 12B), refinance their vehicle loans (FIGS. 13A and 13B), or to obtain cash (FIGS. 14A and 14B) operate in a similar fashion; users are presented with questions and supply answers which are received and processed by server 11. If the user indicates that they already have a mortgage or a home equity loan, the web pages illustrated in FIGS. 15A and 15B, respectively, are presented.

The screens illustrated in FIGS. 12A and 12B are presented to a user who wishes to refinance their homes. Here, the user is asked to indicate what their preferred financial goal is. The user may wish to lower their interest costs and pay off their loan in the same time as their current loan. Alternately, the user may want to lower their payments, but pay off their loan in the same amount of time as their current loan. Finally, the user may opt to lower their payments, even if it takes them longer to pay off their new loan. The present invention is not limited in scope to these specific user goals. The user may be presented with other financial goal options.

In each scenario, information regarding a particular user is received by server 11 via communications network 22, and the information processed by server 11 utilizing information stored in local database 16 and/or remote database 20, and responsive loan-related information is displayed on the user's terminal 24. This responsive information informs the user of the best possible loan currently available, based on the user's financial goals, present financial status, as well as other underwriting factors mentioned above. This is performed by comparing the user's inputs against the underwriting factors to identify all the loans for which the user could qualify. If the user's goal is to minimize total payments, the system will select the loan that has the lowest total combination of monthly payments, closing costs and mortgage insurance (where relevant) over the requested hold period. If the user's goal is to minimize after-tax interest, the system will select the loan with the lowest present value amount for interest, closing costs and mortgage insurance (where relevant) combined. In the case where refinancing a loan is being considered, the new loan must offer savings over the current loan.

For users that own a home, there are a number of possible loan options that are presented to the user taking into account the loans the user currently have. For example, if a user wants to save on their current vehicle loan, then the possible loan options are: Auto Refinance to refinance the user's current vehicle loan with a new vehicle loan; a Mortgage Refinance to obtain a cash-out refinance to pay off the current automobile loan; or a Home Equity Loan to obtain a home equity loan to pay off the user's current automobile loan. Other possible loan options that may be presented for a user wanting to save on their current vehicle loan are as follows, where loans in italics indicate a new suggested loan which may be combined with the user's existing loan:

I. User's Current Loans: Vehicle Loan and Home Equity

Possible Loan Options:
Auto Refinance/Home Equity—Refinance the automobile loan with a new automobile loan and keep the current home equity loan.
Home Equity—Get a new home equity loan that pays off the current automobile loan and home equity loan.
Mortgage Refinance—Get a cash-out refinance to pay off the automobile loan and home equity loan.

II. User's Current Loans: Vehicle Loan and Mortgage

Possible Loan Options:
Auto Refinance/Mortgage—Refinance the automobile loan with a new automobile loan and keep the current mortgage.
Home Equity—Get a home equity loan to pay off the automobile loan and mortgage.
Mortgage Refinance—Get a cash-out refinance to pay off the automobile loan and mortgage.
Home Equity/Mortgage—Get a home equity loan to pay off the automobile loan and keep the current mortgage.

III. User's Current Loans: Vehicle Loan and Home Equity and Mortgage

Possible Loan Options:
Auto Refinance/Home Equity/Mortgage—Refinance the automobile loan and keep the current home equity loan and mortgage.
Home Equity—Pay off all three loans with a home equity loan.
Mortgage Refinance—Pay off all three loans with a cash-out refinance.
Home Equity/Mortgage—Pay off the home equity loan and automobile loan with a home equity loan and keep the current mortgage.
Home Equity/Mortgage—Pay off the current mortgage and vehicle loan with a cash-out refinance and keep the current home equity loan.

IV. User's Current Loans: Vehicle Loan (No Mortgage, but Owns a Home)

Possible Loan Options:
Auto Loan—Get an automobile loan to refinance the current vehicle loan.
Home Equity—Get a home equity loan to pay off the current vehicle loan.
Mortgage Refinance—Get a cash-out refinance to pay off the current vehicle loan.

For a user wishing to purchase a new vehicle or a used vehicle from a franchised dealership or another situation where a vehicle loan is not an option, the following loan options are considered:

IV. User's Current Loans: None (No Mortgage, but Owns a Home)

Possible Loan Options:
Auto Loan—Get an automobile loan to buy the vehicle.
Home Equity—Get a home equity loan to buy the vehicle.
Mortgage Refinance—Get a cash-out refinance to buy the vehicle.

V. User's Current Loans: Home Equity

Possible Loan Options:
Auto Loan/Home Equity—Get an automobile loan to buy the vehicle and keep the current home equity loan.
Home Equity—Get a home equity loan to pay off the current home equity loan and get cash to buy the vehicle.
Mortgage Refinance—Get a cash-out refinance to pay off the current home equity loan and get cash to buy the vehicle.

VI. User's Current Loans: Mortgage

Possible Loan Options:
Auto Loan/Mortgage—Get an automobile loan to buy the vehicle and keep the current mortgage.
Home Equity—Get a home equity loan to pay off the current mortgage and get cash to buy the vehicle.
Mortgage Refinance—Get a cash-out refinance to pay off the current mortgage and get cash to buy the vehicle.
Home Equity/Mortgage—Get a home equity loan to get cash to buy the vehicle and keep the current mortgage.

VII. User's Current Loans: Home Equity and Mortgage

Possible Loan Options:
Auto Loan/Home Equity/Mortgage—Get an automobile loan to buy the vehicle and keep the current home equity loan and mortgage.
Home Equity—Get a home equity loan to pay off the current home equity and mortgage and get cash to buy the vehicle.
Mortgage Refinance—Get a cash-out refinance to pay off the current home equity and mortgage and get cash to buy the vehicle.
Home Equity/Mortgage—Get a home equity loan to pay off the current home equity, get cash to buy the vehicle, and keep the current mortgage.
Home Equity/Mortgage—Get a mortgage to pay off the current mortgage, get cash to buy the vehicle, and keep the current home equity loan.

For the scenario in which the user wants to buy a used vehicle from a non-franchised dealership or another situation where a vehicle loan is not an option, the following loan options are available:

VIII. User's Current Loans: None (No Mortgage, but Owns a Home)

Possible Loan Options:
Home Equity—Get a home equity loan to get cash to buy the vehicle.
Mortgage Refinance—Get a cash-out refinance to get cash to buy the vehicle.
Personal Loan—Get a personal loan to get cash to buy the vehicle.

IX. User's Current Loans: Home Equity

Possible Loan Options:
Home Equity—Get a home equity loan to pay off the current home equity loan and get cash to buy the vehicle.
Mortgage Refinance—Get a cash-out refinance to pay off the current home equity and get cash to buy the vehicle.
Personal Loan/Home Equity—Get a personal loan to get cash to buy the vehicle and keep the current home equity loan.

X. User's Current Loans: Mortgage

Possible Loan Options:
Home Equity—Get a home equity loan to pay off the current mortgage and get cash to buy the vehicle.
Mortgage Refinance—Get a cash-out refinance to pay off the current mortgage and get cash to buy the vehicle.
Home Equity/Mortgage—Get a home equity loan to get cash to buy the vehicle and keep the current mortgage.
Personal Loan/Mortgage—Get a personal loan to get cash to buy the vehicle and keep the current mortgage.

XI. User's Current Loans: Home Equity and Mortgage

Possible Loan Options:
Home Equity—Get a home equity loan to pay off the current mortgage and home equity loan and get cash to buy the vehicle.
Mortgage Refinance—Get a cash-out refinance to pay off the current mortgage and home equity loan and get cash to buy the vehicle.
Home Equity/Mortgage—Get a home equity loan to pay off the current home equity, get cash to buy the vehicle, and keep the current mortgage.
Personal Loan/Home Equity/Mortgage—Get a personal loan to get cash to buy the vehicle and keep the current home equity loan and mortgage.
Home Equity/Mortgage—Get a cash-out refinance to pay off the current mortgage, get cash to buy the vehicle, and keep the current home equity loan.

Yet another scenario is where the user who has no current loans seeks a loan in order to purchase a house; for that user the following loan options are available:

XII. User's Current Loans; N/A

Possible Loan Options:

New Loans:
Mortgage—Buy the house with a new mortgage.
Mortgage/Home Equity—Buy the house with a new mortgage and home equity loan.

If a user already owns a house and wants a loan to reduce his or her current mortgage payments, the following loan options are available:

XIII. User's Current Loan: Mortgage

Possible Loan Options:
Home Equity—Pay off the current mortgage with a new home equity loan.
Mortgage Refinance—Pay off the current mortgage with a mortgage.

XIV. User's Current Loans: Home Equity and Mortgage

Possible Loan Options:
Home Equity—Pay off both the current mortgage and home equity loan with a new home equity loan.
Mortgage Refinance—Pay off both the current mortgage and home equity loan with a new mortgage.
Home Equity/Mortgage Refinance—Pay off the current mortgage and keep the current home equity loan.

Finally, if the user wants to obtain cash, the following are the loan options that will be presented to the user, depending upon the user's current loans:

XV. User's Current Loans: None (No Mortgage, but Owns a Home)

Possible Loan Options:
Home Equity—Get cash with a home equity loan.
Mortgage Refinance—Get cash with a cash-out refinance.
Personal Loan—Get cash with a personal loan.

XVI. User's Current Loans: Home Equity

Possible Loan Options:
Home Equity—Pay off the current home equity with a new home equity and get cash.
Mortgage Refinance—Pay off the current home equity with a cash-out refinance and get cash.
Personal Loan/Home Equity—Get a personal loan to get cash and keep the current home equity loan.

XVII. User's Current Loans: Mortgage

Possible Loan Options:
Home Equity—Pay off the current mortgage with a home equity loan and get cash.
Mortgage Refinance—Pay off the current mortgage with a cash-out refinance and get cash.
Home Equity/Mortgage—Get a home equity to get cash and keep the current mortgage.
Personal Loan/Mortgage—Get a personal loan to get cash and keep the current mortgage.

XVIII. User's Current Loans: Home Equity and Mortgage

Possible Loan Options:
Home Equity—Pay off the current home equity and mortgage with a home equity loan and get cash.
Mortgage Refinance—Pay off the current home equity and mortgage with a cash-out refinance and get cash.
Home Equity/Mortgage—Pay off the current home equity with a new home equity loan, get cash, and keep the current mortgage.
Home Equity/Mortgage—Pay off the current mortgage with cash-out refinance, get cash, and keep the current home equity loan.
Personal Loan/Home Equity/Mortgage—Get cash with a personal loan and keep the current home equity and mortgage.

Once the various possible loan options are determined, the processor within server 11 of the present invention utilizes specific algorithms to determine which loans will save the user the most money by calculating the cost over a period of time that is specified by the user. If the user's goal is to minimize total payments, the present invention adds closing costs, principal, interest, and mortgage insurance, such as mortgage insurance, if applicable, paid over the specified period of time. If the user's goal is to minimize after-tax interest, then the system of the present invention adds interest, closing costs, and, if applicable, mortgage insurance. Points and interest (for home loans up to 100% of the property value) are adjusted for taxes in the “minimize after-tax interest” scenario. Points are tax deductible in year one for Purchase loans and over the life of the loan for Refinance and Home Equity loans. Multiplying the tax rate the user provided by the amount of interest and points paid determines the tax adjustment. This methodology is applied to both the user's current loans and new loans.

The algorithms used by the loan advising system of the present invention discern the type of loan the user is seeking and then applies a distinct algorithm for that loan purpose. For example, automobile loans have a fixed interest rate, therefore there is no need to obtain an interest rate forecast from an exterior information source. The following calculation for automobile loans applies for all loan uses, i.e. new, used, and refinanced vehicle loans and is distinguished by the user's choice of goal. The server performs the calculation below for all available loans and determines which would provide the lowest cost to the user, where “lowest cost” varies depending upon the user's chosen savings goal.
Loan Amount=amount of money the user wants to borrow
T=term of the loan
IR=investment rate

Minimize Total Payment Option:
Calculate the sum of: (payments in year one)+(payments in year two)/(1+IR)+ . . . +(payments in year T)/(1+IR)\hat{ }T

Minimize After-Tax Interest Option:
Calculate the sum of: (interest portion of the payments in year one)+(interest portion of the payments in year two)/(1+IR)+ . . . +(interest portion of the payments in year T)/(1+IR)\hat{ }T

Home equity loans generally have a fixed interest rate at least for a long period of time, so once again, no interest rate forecast is needed. Home equity lines of credit are typically based on an index such as the prime rate. Since the prime rate is a variable rate, it will have to be forecast into the future so the line of credit interest rate can be forecast. The present invention uses the current treasury yield curve and adds an adjustment figure, such as 3.0%, as a margin to the treasury yield curve to derive a prime rate yield curve. This prime rate yield curve is then adjusted by the chosen margin to determine the line of credit interest rate. The following calculation applies to all home equity products including lines of credit and fixed loans.
Loan Amount=amount of money the user wants to borrow+balance of current second mortgage OR amount of money the user wants to borrow+balance of current first and second mortgage
T=term of the loan
N=time frame the user will be keeping the loan
IR=investment rate

Minimize Total Payment Option:
Calculate the sum of: (closing costs+points+payments in year one)+(payments in year two)/(1+IR)+ . . . +(payments in year N)/(1+IR)\hat{ }N

Minimize After-Tax Interest Option:
Calculate the sum of: (interest portion of the payments in year one)*(1−tax rate)+closing costs+points−(points/T*tax rate)+(interest portion of the payments in year two)*(1−tax rate)−(points/T*tax rate)/(1+IR)+ . . . +(interest portion of the payments in year N)*(1−tax rate)−((T−N)/T*points*tax rate)/(1+IR)\hat{ }N

Mortgages may have a fixed rate or a variable rate. If the mortgage has a fixed interest rate, then no interest rate forecast is needed. If the mortgage has a variable rate, then the interest rate will have to be forecast into the future. The current treasury yield curve is used and then adjusted by the margin to determine the mortgage rate. The following calculation applies to all mortgage products including Adjustable Rate Mortgages (ARMs) and fixed loans, for purchase, refinance, and refinance loans with cash out options.
T=term of the loan
N=time frame the user will keep the loan
IR=investment rate

Minimize Total Payment Option: Taxes are not Part of the Calculation.
Calculate the sum of: (closing costs+points+payments in year one)+(payments in year two)/(1+IR)+ . . . +(payments in year N)/(1+IR)\hat{ }N

Minimize After-Tax Interest Option:
T=term of the loan
N=time frame the user will keep the loan
IR=investment rate

Refinance:
Calculate the sum of: (interest portion of the payments in year one)*(1−tax rate)+closing costs+points−(points/T*tax rate)+(interest portion of the payments in year two)*(1−tax rate)−(points/T*tax rate)/(1+IR)+ . . . +(interest portion of the payments in year N)*(1−tax rate)−((T−N)/T*points*tax rate)/(1+IR)\hat{ }N

Purchase:
Calculate the sum of: (interest portion of the payments in year one+points)*(1−tax rate)+closing costs)+(interest portion of the payments in year two)*(1−tax rate)/(1+IR)+ . . . +(interest portion of the payments in year N)*(1−tax rate)/(1+IR)\hat{ }N

If the loan advisory system 10 of the present invention chooses a mortgage as the optimal loan option, it will suggest to the user the best loan in each of up to three loan categories to accommodate the differences in user risk preference and tolerance. The user may choose how many loans in each category he or she wishes to see. For example, the system will suggest “Recommended Loan”, which is the least conservative category. Under this loan category, the system will display the loan with the greatest savings without excluding any loan types. Interest-only loans, loans with a prepayment penalty and home equity loans in place of a first mortgage are all evaluated.

A second loan category that is suggested to the user does not consider loans with a pre-payment penalty, interest-only payments, and home equity loans as the only mortgage, even if they were to yield the lowest cost. This loan category is considered “More Conservative” and is not displayed if the “Recommended Loan” already meets the extra criteria.

A third category that may be presented to a user if a mortgage is selected as one of the loan options is the “More Conservative, Fixed Rate Loan” category. This category goes one step further and also eliminates adjustable rate mortgages from the consideration set. It will show the lowest cost fixed rate, “traditional” mortgage. This category is not displayed if the “Recommended Loan” or “More Conservative Loan” categories already satisfy the extra criteria. The various loan categories are presented to users to account for different levels of acceptable user risk.

If the loan advisory system of the present invention determines that the optimal loan option is a home equity loan such that the user will keep their current first mortgage, the lowest cost home equity loans and lines of credit will both be presented to the user. Finally, if automobile loans are suggested, and considering that automobile loans have no closing costs, only rates and terms distinguish one automobile loan from one another. As a result, all automobile loans are displayed if an automobile loan option is recommended.

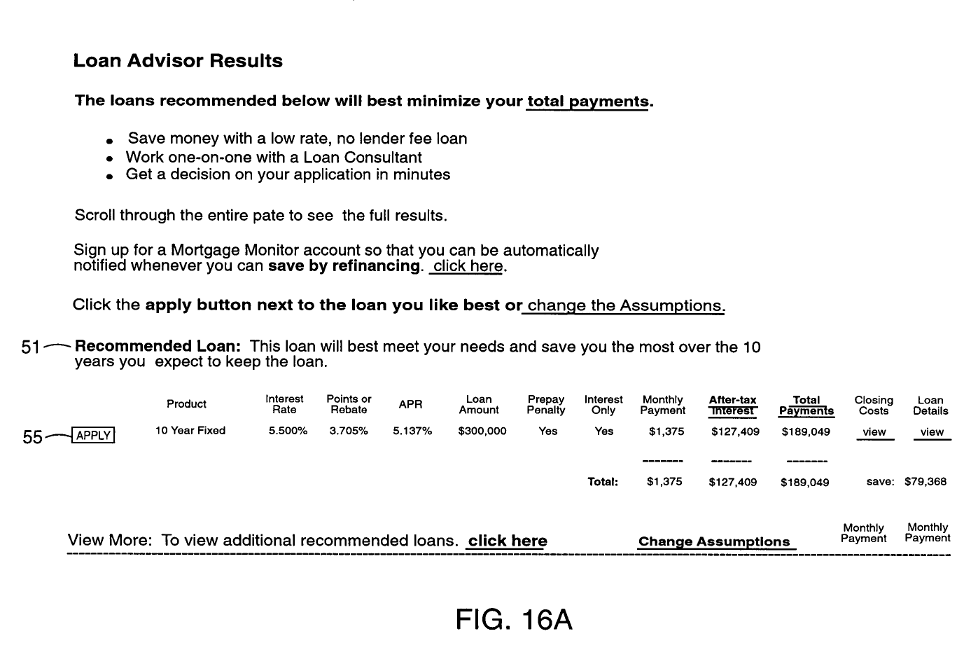

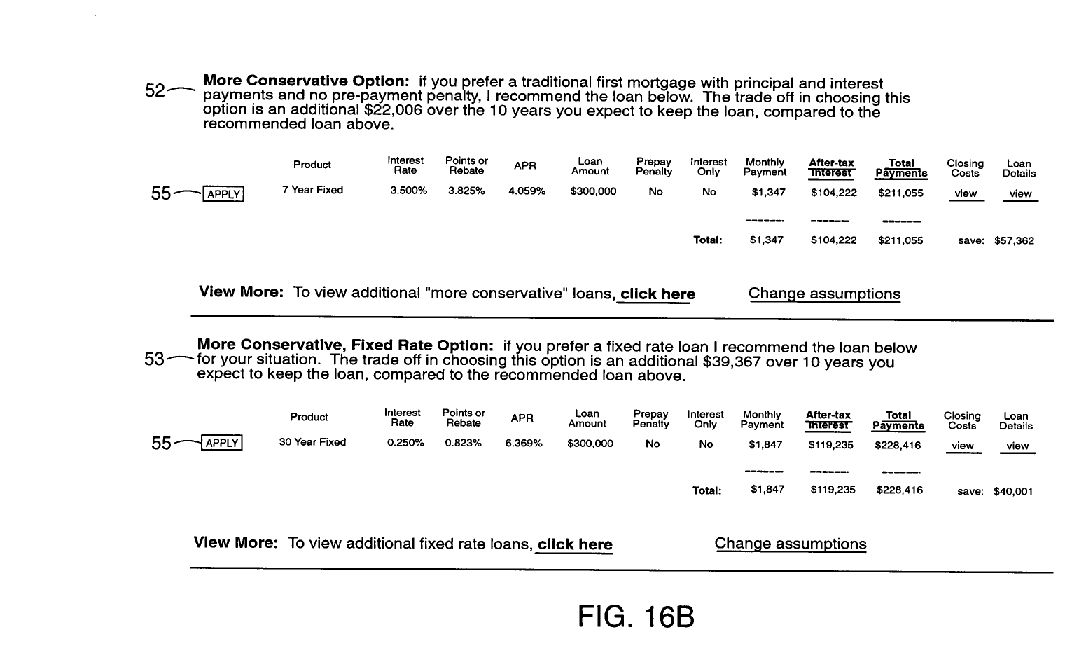

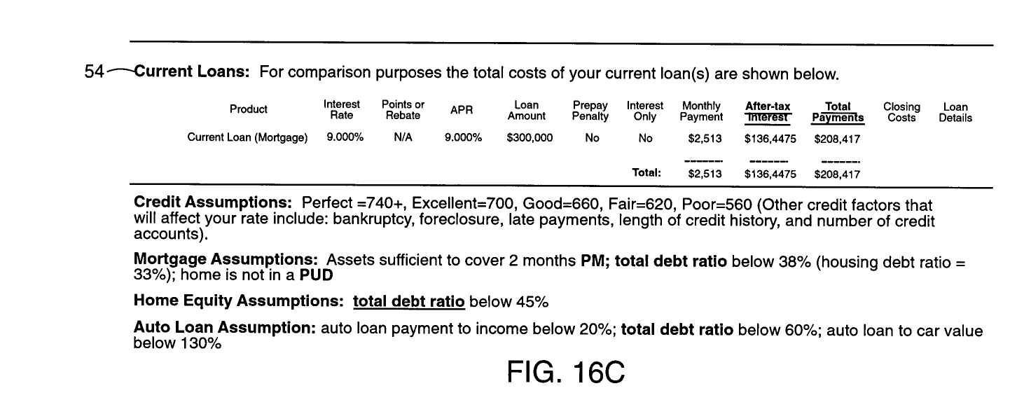

FIGS. 16A through 19B refer to output web pages that are presented to the user after the loan advisory system of the present invention has calculated the optimal loan options and loans for a particular user. FIGS. 16A-16C illustrate a web page presented to a user that recommends a mortgage. Each of the three mortgage categories recommended take into consideration the user's choice of minimizing their total payments. Three mortgage categories are recommended to the user. In FIG. 16A, a Recommended Loan category 51 is presented, which, in this case suggests a 10 year fixed mortgage at an interest rate of 5.5%. In FIG. 16B, a “More Conservative Option” 52 suggests a 7 year fixed rate mortgage at 3.5%. In FIG. 16B, a third mortgage category, “More Conservative, Fixed Rate Option” 53 is presented, suggesting a 30 year fixed rate mortgage at 6.25%. FIG. 16C lists the user's current loan 54 as a comparison to the recommended loans. The “APPLY” button 55 allows the user to directly apply for the selected loan.

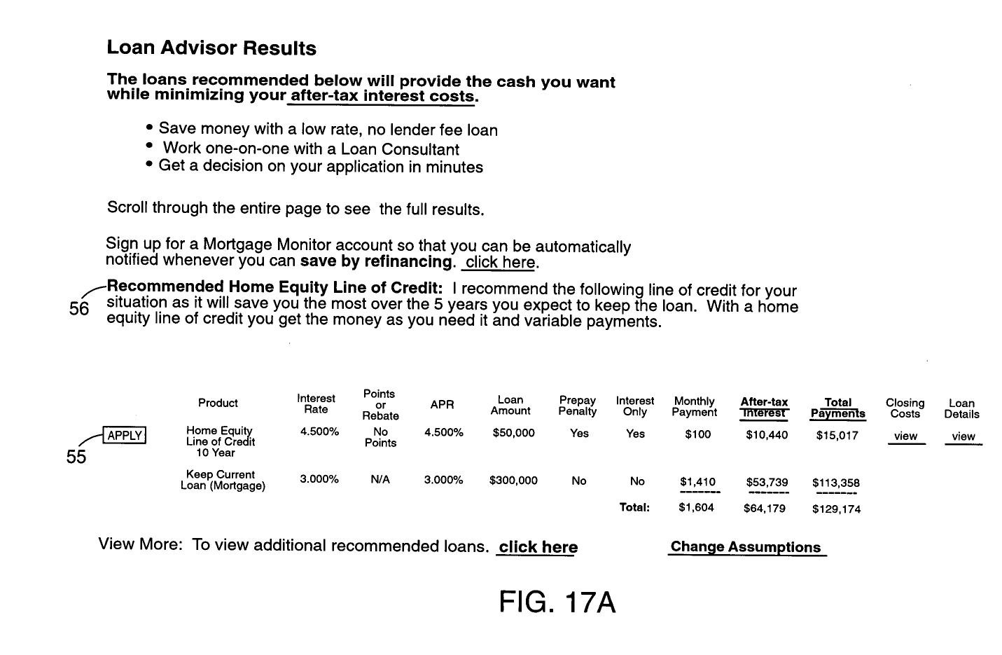

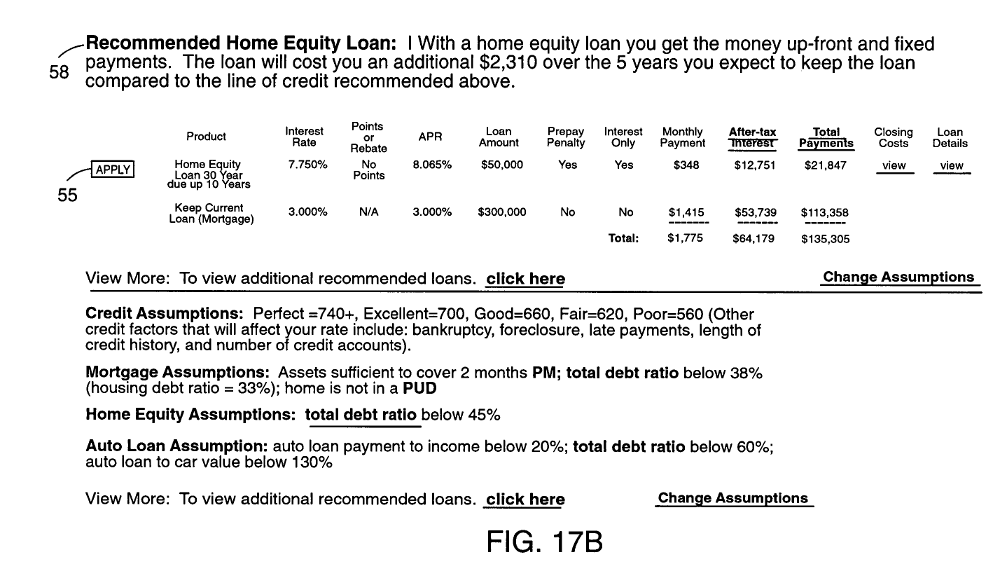

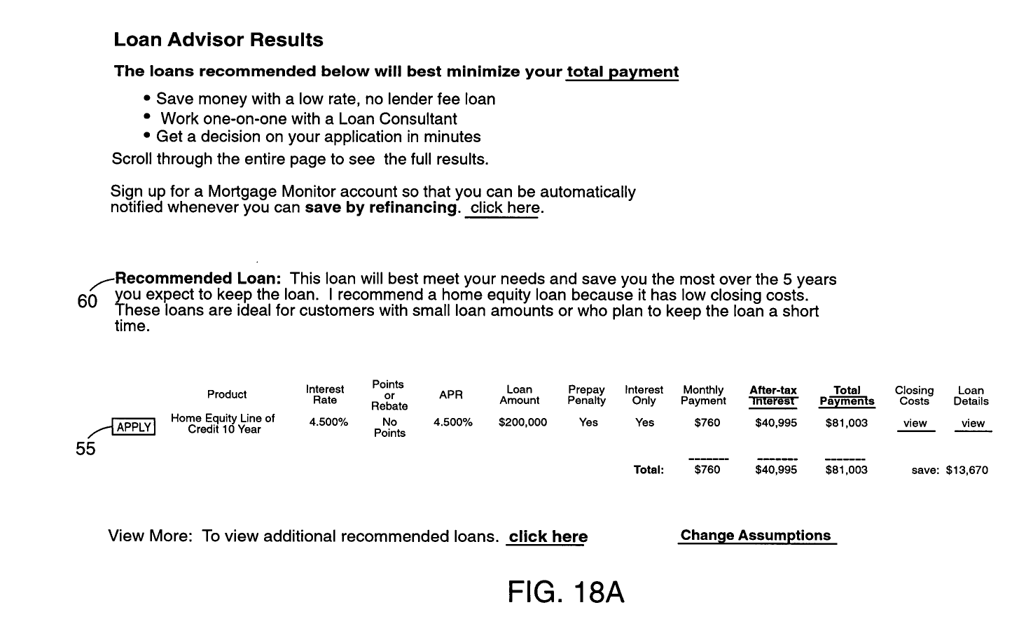

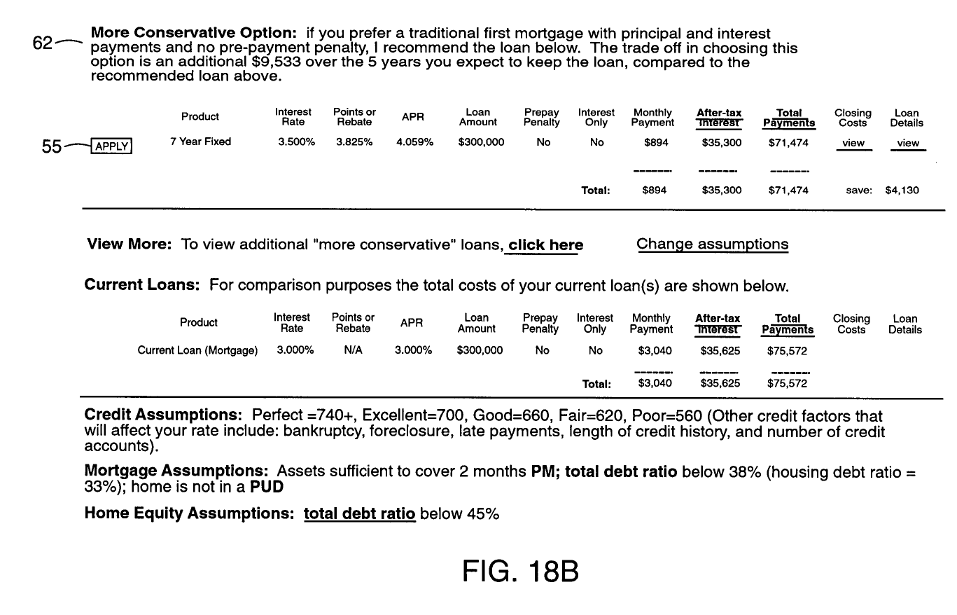

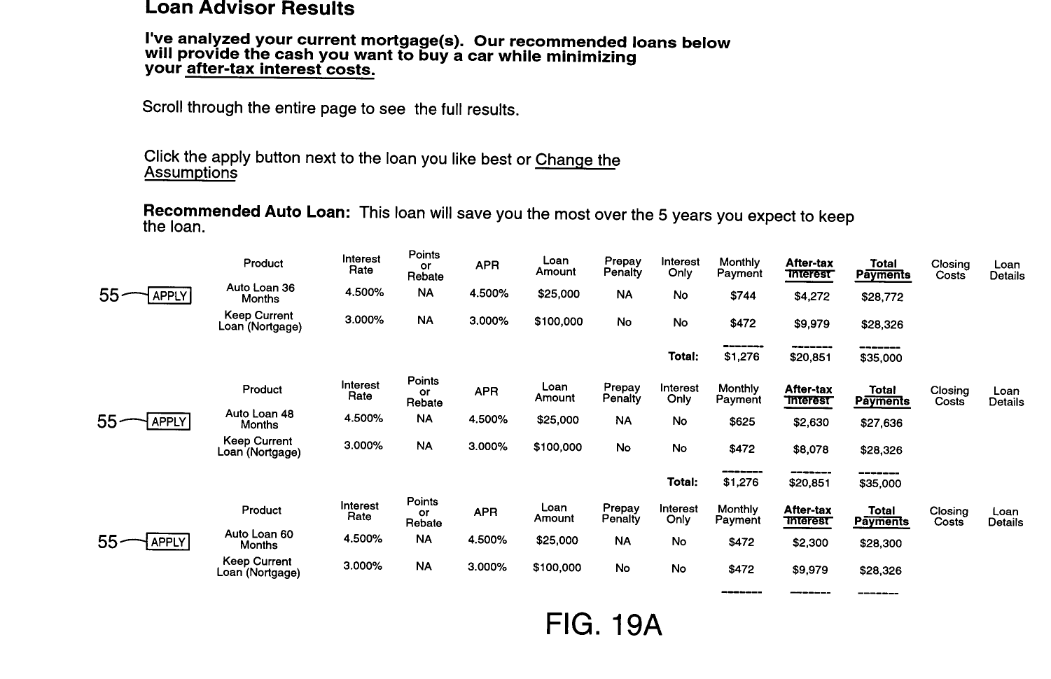

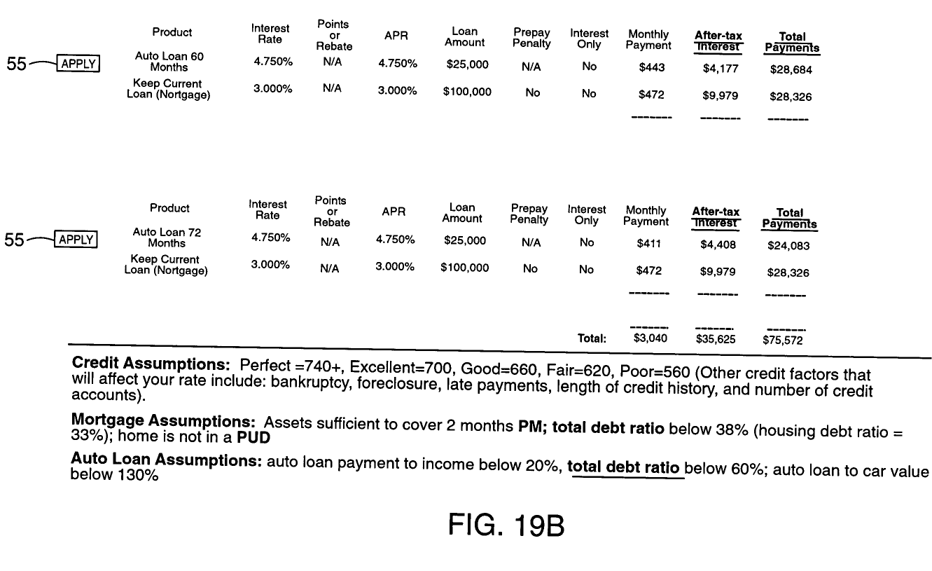

FIGS. 17A and 17B illustrate output web screens presented to a user who wishes to minimize after-tax interest costs. In this scenario, a home equity line of credit 56 is recommended (FIG. 17A) as well as a home equity loan 58 (FIG. 17B). Other general loan-related information is shown on these pages including benefits of a home equity loan or line of credit, specifics about the recommended loan such as monthly payment amount, the existence of any prepayment penalties and assumptions that were used to calculate the recommended loan. FIGS. 18A and 18B are web screens that suggest a home equity loan as the only mortgage. Once again, these figures illustrate results obtained for a user seeking to minimize their total payments. In this scenario, a recommended loan 60 is presented (FIG. 18A), along with a more conservative loan 62 (FIG. 18B). FIGS. 19A and 19B show output web screens when an automobile loan is recommended and where the user seeks to minimize after-tax interests costs. Here, four automobile loans are recommended, with varying interest rates and loan terms.

It should be noted that after one or more loans are recommended to a user, the user may choose to apply for one of the recommended loans directly through the host website, via activation of button 55. In this instance, a loan application is presented and the user may enter the information. The host server receives this information and may forward it to the appropriate lending institution for processing.

The present invention provides an interactive loan advisory system and method that provides users with optimal loan choices in a broad range of loan categories based upon a user's specific financial goals and status. The loan advisory system of the present invention obtains real-time loan rates and determines, via a variety of algorithms, the loan or loans that would be most cost-effective to a user, incorporating the user's preferred savings goal. The invention is not restricted to one type of loan category but instead examines a variety of loan categories and, if there is more than one loan option available, presents the user with a recommended loan as well as a more conservative loan option. The invention also allows the user to directly apply for the loan of their choosing.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A method of recommending loans to a user based upon a user-selected loan purpose, the method comprising:
requesting from the user a purpose for the loan;
receiving the user-selected loan purpose; and
recommending loans for the user based upon the user-selected loan purpose.

2. The method of claim 1 further comprising determining if the user is a homeowner.

3. The method of claim 2 further comprising, if the user is determined not to be a homeowner and if the user-selected loan purpose is not purchasing a home, suggesting to the user one or more loan options based on the user-selected loan purpose.

4. The method of claim 2 further comprising, if the user is determined not to be a homeowner and if the user-selected loan purpose is not purchasing a home, suggesting to the user one or more collateralized loan options based on the user-selected loan purpose.

5. The method of claim 2 further comprising, if the user is a homeowner or if the user-selected loan purpose is to purchase a home:
receiving from the user one or more loan-related input parameters;
determining which loans are to be recommended to the user based upon the user-selected loan purpose and the one or more loan-related input parameters; and
suggesting to the user one or more loans based upon the user-selected loan purpose and the one or more loan-related input parameters.

6. The method of claim 5 wherein suggesting to the user the one or more loans based upon the user-selected loan purpose and the one or more loan-related input parameters comprises providing the user with multiple loan recommendations based upon a level of acceptable user risk.

7. The method of claim 5 wherein determining which loans are to be recommended to the user further comprises:
searching for additional loan-related input parameters; and
incorporating said additional loan-related input parameters into the step of determining which loans are to be recommended to the user.

8. The method of claim 7 wherein one of the one or more loan-related input parameters is the user's credit rating.

9. The method of claim 7 wherein the user's credit rating is a real-time input parameter.

10. The method of claim 7 wherein one of the one or more loan-related input parameters is the user's current loan status, wherein the user's current loan status is determined by whether the user currently has one or more outstanding loans.

11. The method of claim 7 wherein one of the one or more loan-related input parameters is the user's goal.

12. The method of claim 11 wherein the user's goal is to minimize total payments.

13. The method of claim 11 wherein the user's goal is to minimize after-tax interest costs.

14. The method of claim 11 wherein, if the user has one or more outstanding loans, the user's goal is to pay off the suggested loan in the same amount of time as the time remaining on the user's one or more outstanding loans.

15. The method of claim 11 wherein determining which loans are to be recommended to the user comprises:
determining which loan options are available to the user based upon the user's loan purpose and the user's current loan status; and
calculating the most cost-effective loans for each said loan option based upon the user's goal.

16. The method of claim 15 wherein, if the user's loan purpose is to purchase a vehicle or to refinance an existing vehicle loan and the user's goal is to minimize total payments, calculating the most cost-effective loans for each said loan option comprises:
determining an annual amount the user must pay towards an outstanding principal portion of the loan;
adjusting the annual amount by a fixed interest rate;
summing the adjusted annual amounts for a term of the loan to obtain loan-specific total principal payments;
comparing the loan-specific total principal payments of one or more available loans; and
choosing one or more of the one or more available loans having a lowest total principal payment.

17. The method of claim 15 wherein, if the user's loan purpose is to purchase a vehicle or refinance an existing vehicle loan and the user's goal is to minimize after-tax interest payments, calculating the most cost-effective loans for each said loan option comprises:
determining an annual amount the user must pay towards an outstanding interest portion of the loan;
adjusting the annual amount by a fixed interest rate;
summing the adjusted annual amounts for a term of the loan to obtain loan-specific total interest payments;
comparing the loan-specific total interest payments of one or more available loans; and
choosing one or more of the one or more available loans having a lowest total interest payment.

18. The method of claim 15 wherein, if the user's loan purpose is to obtain cash or to save on their mortgage and the user's goal is to minimize total payments, calculating the most cost-effective loans for each said loan option comprises:
determining an annual amount the user must pay towards an outstanding principal portion of the loan;
adjusting the annual amount by addition of applicable closing costs and points;
adjusting the annual amount by a fixed interest rate;
summing the adjusted annual amounts for a term the user intends to keep the loan to obtain total loan-specific principal payments;
comparing the total loan-specific payments of one or more available loans; and
choosing one or more of the one or more available loans having the lowest total payment.

19. The method of claim 15 wherein, if the user's loan purpose is to obtain cash or to save on their mortgage and the user's goal is to minimize after-tax interest payments, calculating the most cost-effective loans for each said loan option comprises:
determining an annual amount the user must pay towards an outstanding interest portion of the loan;
adjusting the annual amount by addition of applicable closing costs, points and tax rate;
summing the adjusted annual amounts for a term the user intends to keep the loan to obtain loan-specific total interest payments;
comparing the total loan-specific interest payments of one or more available loans; and
choosing one or more of the one or more available loans having lower total interest payments.

20. A system for recommending loans to a user associated with a user station, the system comprising:
a communications network; and
a server operatively connected to the communications network;
wherein the server transmits requests for a user-selected loan purpose, each user station being associated with a respective display terminal for displaying a web page, the server further receiving a transmittal containing the user-selected loan purpose from each said user station and recommending loans for each of the one or more users based upon the user-selected loan purpose.

21. The system of claim 20 further comprising a database including user profile information.

22. The system of claim 20 wherein the server is capable of determining if each said user is a homeowner.

23. The system of claim 22 wherein, if the user is determined not to be a homeowner and if the user-selected loan purpose is not purchasing a home, the server transmits to the user a suggestion for one or more unsecured loan options tailored to the user-selected loan purpose.

24. The system of claim 20 wherein, if the user is determined not to be a homeowner and if the user-selected loan purpose is not purchasing a home, the server transmits to the user a suggestion for one or more collateralized loan options tailored to the user-selected loan purpose.

25. The system of claim 22 wherein, if the user is a homeowner or if the user-selected loan purpose is to purchase a home, the server is further adapted to receive a transmittal from the user comprising one or more loan-related input parameters, determine which loans are to be recommended to the user based upon the user-selected loan purpose and the one or more loan-related input parameters, and transmit to the user a suggestion of one or more loans based upon the user-selected loan purpose and the one or more loan-related input parameters.

26. The system of claim 25 further comprising an information storage facility operatively connected to the communications network, the information database including searchable loan-related input parameters, wherein the server incorporates said searchable loan-related input parameters into recommending loans to the user.

27. The system of claim 25 wherein one of the one or more loan-related input parameters is the user's credit rating.

28. The system of claim 27 wherein the user's credit rating is real-time input parameter.

29. The system of claim 25 wherein one of the one or more loan-related input parameters is the user's current loan status, wherein the user's current loan status is determined by whether the user currently has one or more outstanding loans.

30. The system of claim 27 wherein one of the one or more loan-related input parameters is the user's goal.

31. The system of claim 30 wherein the user's goal is to minimize total payments.

32. The system of claim 30 wherein the user's goal is to minimize after-tax interest costs.

33. The system of claim 30 wherein, if the user has one or more outstanding loans, the user's goal is to pay off the suggested loan in the same amount of time as the time remaining on the user's one or more outstanding loans.

34. The system of claim 30 wherein the server is adapted to determine which loan options are available to the user based upon the user's loan purpose and the user's current loan status and is further adapted to calculate the most cost-effective loans for each said loan option based upon the user's goal.

35. A machine readable medium having instructions stored thereon for execution by a processor to perform a method of recommending loans to a user based upon a user-selected loan purpose, the method comprising:
requesting from the user a purpose for the loan;
receiving the user-selected loan purpose; and
recommending loans for the user based upon the user-selected loan purpose.

36. The medium of claim 35, wherein the method of recommending loans to the user based upon a user-selected loan purpose further comprises determining if the user is a homeowner.

37. The medium of claim 36 wherein, if the user is determined not to be a homeowner and if the user-selected loan purpose is not purchasing a home, the method of recommending loans to the user based upon a selected loan purpose further comprises suggesting to the user one or more unsecured loan options based on the user-selected loan purpose.

38. The medium of claim 36 wherein, if the user is determined not to be a homeowner and if the user-selected loan purpose is not purchasing a home, the method of recommending loans to the user based upon a selected loan purpose further comprises suggesting to the user one or more collateralized loan options tailored to the user-selected loan purpose.

39. The medium of claim 36 wherein, if the user is a homeowner or if the user-selected loan purpose is to purchase a home, the method of recommending loans to the user based upon a selected loan purpose further comprises:
receiving from the user one or more loan-related input parameters;
determining which loans are to be recommended to the user based upon the user-selected loan purpose and the one or more loan-related input parameters; and
suggesting to the user one or more loans based upon the user-selected loan purpose and the one or more loan-related input parameters.

40. The medium of claim 39 wherein suggesting to the user one or more loans based upon the user-selected loan purpose and the one or more loan-related input parameters comprises providing the user with multiple loan recommendations based upon a level of acceptable user risk.

41. The medium of claim 39 wherein determining which loans are to be recommended to the user further comprises searching for additional loan-related input parameters and incorporating said additional loan-related input parameters into the step of determining which loans are to be recommended to the user.

42. The medium of claim 41 wherein one of the one or more loan-related input parameters is the user's credit rating.

43. The medium of claim 42 wherein the user's credit rating is a real-time input parameter.

44. The medium of claim 39 wherein one of the one or more loan-related input parameters is the user's current loan status, wherein the user's current loan status is determined by whether the user currently has one or more outstanding loans.

45. The medium of claim 44 wherein one of the one or more loan-related input parameters is the user's goal.

46. The medium of claim 45 wherein the user's goal is to minimize total payments.

47. The medium of claim 45 wherein the user's goal is to minimize after-tax interest costs.

48. The medium of claim 45 wherein, if the user has one or more outstanding loans, the user's goal is to pay off the suggested loan in the same amount of time as the time remaining on the user's one or more outstanding loans.

49. The medium of claim 45 wherein determining which said one or more loans are to be recommended to the user comprises:
determining which loan options are available to the user based upon the user's loan purpose and the user's current loan status; and
calculating the most cost-effective loans for each said loan option based upon the goal.

50. The medium of claim 49 wherein, if the user's loan purpose is to purchase a vehicle or to refinance an existing vehicle loan and the user's goal is to minimize total payments, calculating the most cost-effective loans for each said loan option comprises:
determining an annual amount the user must pay towards an outstanding principal portion of the loan;
adjusting the annual amount by a fixed interest rate;
summing the adjusted annual amounts for a term of the loan to obtain loan-specific total principal payments;
comparing the loan-specific total principal payments of one or more available loans; and
choosing one or more of the one or more available loans having a lowest total principal payment.

51. The medium of claim 49 wherein, if the user's loan purpose is to purchase a vehicle or refinance an existing vehicle loan and the user's goal is to minimize after-tax interest payments, calculating the most cost-effective loans for each said loan option comprises:
determining an annual amount the user must pay towards an outstanding interest portion of the loan;
adjusting the annual amount by a fixed interest rate;
summing the adjusted annual amounts for a term of the loan to obtain loan-specific total interest payments;
comparing the loan-specific total interest payments of one or more available loans; and
choosing one or more of the one or more available loans having a lowest total interest payment.

52. The medium of claim 49 wherein, if the user's loan purpose includes getting cash and the user's goal is to minimize total payments, calculating the most cost-effective loans for each said loan option comprises:
determining an annual amount the user must pay towards an outstanding principal portion of the loan;
adjusting the annual amount by addition of applicable closing costs and points;
adjusting the annual amount by a fixed interest rate;
summing the adjusted annual amounts for a term the user intends to keep the loan to obtain a loan-specific total principal payment;
comparing the loan-specific total principal payments of one or more available loans; and
choosing one or more of the one or more available loans having a lowest total principal payment.

53. The medium of claim 49 wherein, if the user's loan purpose involves is to obtain cash or to save on their mortgage and the user's goal is to minimize after-tax interest payments, calculating the most cost-effective loans for each said loan option comprises:
determining an annual amount the user must pay towards an outstanding interest portion of the loan;
adjusting the annual amount by addition of applicable closing costs, points and tax rate;
summing the adjusted annual amounts for a term the user intends to keep the loan to obtain a loan-specific total interest payment;
comparing the loan-specific total interest payments of one or more available loans; and
choosing one or more of the one or more available loans having a lowest total interest payment.
